(19) United States
(12) Patent Application Publication
(10) Pub. No.: US 2014/0128093 A1
(43) Pub. Date: May 8, 2014

(54) PORTAL TRANSITION PARAMETERS FOR USE IN MOBILE DEVICE POSITIONING

(71) Applicant: QUALCOMM INCORPORATED, San Diego, CA (US)

(72) Inventors: Saumitra Mohan DAS, Santa Clara, CA (US); Behrooz KHORASHADI, Mountain View, CA (US); Rajarshi GUPTA, Sunnyvale, CA (US); Vinay SRIDHARA, Santa Clara, CA (US)

(73) Assignee: QUALCOMM Incorporated, San Diego, CA (US)

(21) Appl. No.: 13/670,357

(22) Filed: Nov. 6, 2012

(51) Int. Cl. H04W 4/02

(52) U.S. Cl. 455/456.1

(57) ABSTRACT

Various methods, apparatuses and/or articles of manufacture are provided for use in one or more electronic devices to perform and/or otherwise support certain positioning capabilities with regard to a mobile device. For example, certain positioning capabilities may make use of one or more portal transition parameters that may be based, at least in part, on a determined likelihood that a mobile device, if located in a first region of a specific environment and within a threshold area of a portal connecting the first region to a second region of the specific environment, may or may not make use of the portal to transition from the first region to the second region, e.g., through the portal.

### BACKGROUND

1. Field

The subject matter disclosed herein relates to electronic devices, and more particularly to methods, apparatuses and articles of manufacture for use in one or more electronic devices to perform and/or otherwise support certain positioning capabilities in a mobile device.

2. Information

Mobile devices, such as mobile phones, notebook, computers, etc., may have the ability to estimate location and/or position with a high degree of precision using any one of several technologies such as, for example, satellite positioning systems (e.g., GPS and the like), advanced forward-link trilateration (AFLT), just to name a few examples of signal-based positioning systems and/or corresponding signal-based positioning signals. Using high precision location information, applications for a mobile device may provide a user with various services, such as, for example, vehicle/pedestrian navigation, location-based searching, just to name a couple of examples. Here, high precision signal-based location information (e.g., obtained from GPS and/or other signal-based positioning systems) may be processed according to a global coordinate system (e.g., latitude and longitude or earth-centered xyz coordinates). While such use of signal-based location information referenced to a global coordinate system may be useful in providing some services (e.g., outdoor vehicle navigation), such signal-based location information referenced to a global coordinate system may be impractical for other types of services such as indoor pedestrian navigation.

In certain specific environments, such as office buildings, shopping malls, airports, stadiums, etc., certain example signal-based positioning techniques may make use of various terrestrial-based wireless signal transmitting devices, e.g., wireless network access points, cellular network base stations, special-purpose beacon transmitters, etc., that transmit wireless signals which may be received by the mobile device and used for positioning purposes. For example, a mobile device may receive a signal-based positioning signal from a transmitter and based thereon determine a pseudorange between the transmitter and receiver. Hence, for example, positioning may be provided based on trilateration and/or other known signal-based positioning techniques.

In some implementations, a system may provide an electronic map to a mobile device; for example, an indoor navigation system may provide a digital electronic map to mobile devices as they enter a particular indoor space. Such electronic map may show indoor features such as doors, hallways, entry ways, walls, etc., points of interest such as bathrooms, pay phones, room names, stores, etc. Such electronic map may be stored at a server to be accessible by a mobile device through selection of a URL, for example. By obtaining and rendering all or part of an electronic map via a display mechanism, a mobile device may, for example, overlay a current location of the mobile device (and user) over the displayed map to provide the user with additional context.

In certain instances, in addition to an electronic map, an indoor navigation system may selectively provide assistance information to mobile devices to facilitate and/or enable various location based services. Such assistance information may include, for example, information to facilitate measurements of ranges to wireless access points at known fixed locations. For example, “radio heatmap” or “probability heatmap” data indicating and/or otherwise modeling expected RSSI and/or round-trip delay times associated with access points may enable a mobile device to associate signal measurements with locations in a specific environment. Here, for example, grid points may be laid over locations in a specific environment at uniform spacing (e.g., 0.5 meter separation of neighboring grid points), or possibly with non-uniform spacing. Thus, radio heatmap and/or other corresponding probability functions/models may be made available from a computing device (such as a server) for each grid point covering a specific environment.

### SUMMARY

In accordance with certain aspects, a method may be provided which comprises, with a computing platform: identifying a portal connecting a first region within a specific environment and a second region within the specific environment, the portal being identified based, at least in part, on an electronic map corresponding to at least a portion of the specific environment; and computing a portal transition parameter based, at least in part, on a likelihood that a mobile device, if located in the first region and within a threshold area of the portal, transitions from the first region to the second region through the portal, the likelihood being based, at least in part, on a gathered history of mobile devices in the first region and within the threshold area of the portal.

In accordance with certain other aspects, an apparatus may be provided which comprises: means for identifying a portal connecting a first region within a specific environment and a second region within the specific environment, the portal being identified based, at least in part, on an electronic map corresponding to at least a portion of the specific environment; and means for computing a portal transition parameter based, at least in part, on a likelihood that a mobile device, if located in the first region and within a threshold area of the portal, transitions from the first region to the second region through the portal, the likelihood being based, at least in part, on a gathered history of mobile devices in the first region and within the threshold area of the portal.

In accordance with still other aspects, an apparatus may be provided which comprises: memory and a processing unit in communication with the memory and configured to: identify a portal connecting a first region within a specific environment and a second region within the specific environment, the portal being identified based, at least in part, on an electronic map corresponding to at least a portion of the specific environment; and compute a portal transition parameter based, at least in part, on a likelihood that a mobile device, if located in the first region and within a threshold area of the portal, transitions from the first region to the second region through the portal, the likelihood being based, at least in part, on a gathered history of mobile devices in the first region and within the threshold area of the portal.

In accordance with yet other aspects, an article of manufacture may be provided which comprises identify a portal connecting a first region within a specific environment and a second region within the specific environment, the portal being identified based, at least in part, on an electronic map corresponding to at least a portion of the specific environment; and compute a portal transition parameter based, at least in part, on a likelihood that a mobile device, if located in the first region and within a threshold area of the portal, transitions from the first region to the second region through the portal, the likelihood being based, at least in part, on a gathered history of mobile devices in the first region and within the threshold area of the portal.

In accordance with certain further aspects, a method may be provided which comprises, with a mobile device: receiving a portal transition parameter corresponding to at least a portion of an electronic map of a specific environment, the portal transition parameter corresponding to a threshold area of a portal from a first region within the specific environment to a second region within the specific environment, and being based, at least in part, on a gathered history of mobile devices in the first region and within the threshold area of the portal; and determining a likelihood that the mobile device, when located within the threshold area of the portal, transitions from the first region to the second region through the portal, the likelihood being based, at least in part, on the portal transition parameter.

In accordance with certain other aspects, an apparatus may be provided which comprises: means for receiving a portal transition parameter corresponding to at least a portion of an electronic map of a specific environment, the portal transition parameter corresponding to a threshold area of a portal from a first region within the specific environment to a second region within the specific environment, and being based, at least in part, on a gathered history of mobile devices in the first region and within the threshold area of the portal; and means for a likelihood that the mobile device, when located within the threshold area of the portal, transitions from the first region to the second region through the portal, the likelihood being based, at least in part, on the portal transition parameter.

In accordance still other aspects, a mobile device may be provided which comprises: memory, and a processing unit in communication with the memory and configured to: obtain, from the memory, a portal transition parameter corresponding to at least a portion of an electronic map of a specific environment, the portal transition parameter corresponding to a threshold area of a portal from a first region within the specific environment to a second region within the specific environment, and being based, at least in part, on a gathered history of mobile devices in the first region and within the threshold area of the portal; and determine a likelihood that the mobile device, when located within the threshold area of the portal, transitions from the first region to the second region through the portal, the likelihood being based, at least in part, on the portal transition parameter.

In accordance with yet other aspects, an article of manufacture may be provided which comprises a non-transitory computer readable medium having computer implementable instructions stored therein which are executable by a processing unit of a mobile device to: obtain a portal transition parameter corresponding to at least a portion of an electronic map of a specific environment, the portal transition parameter corresponding to a threshold area of a portal from a first region within the specific environment to a second region within the specific environment, and being based, at least in part, on a gathered history of mobile devices in the first region and within the threshold area of the portal; and determine a likelihood that the mobile device, when located within the threshold area of the portal, transitions from the first region to the second region through the portal, the likelihood being based, at least in part, on the portal transition parameter.

In accordance with even further aspects, a method may be provided which comprises, with the mobile device, in response to a determination that the mobile device has at least entered a threshold area of a portal that connects a first region within a specific environment to a second region within the specific environment: gathering navigation information indicative of perceived movements of the mobile device with regard to the portal; and transmitting at least a portion of the navigation information to at least one other device. In certain further instances, at least the portion of the navigation information may be indicative of whether the mobile device transitioned from the first region to the second region via the portal. In still other instances, the method may comprise transmitting the at least the portion of the navigation information to the at least one other device in response to a request from the at least one other device. In yet other instances, the first region may be identifiable by a first location context identifier (LCI) and the second region may be identifiable by a second LCI which is different than the first LCI.

In accordance with still other aspects, an apparatus may be provided for use in a mobile device. For example, such an apparatus may comprise: means for determining whether the mobile device has at least entered a threshold area of a portal that connects a first region within a specific environment to a second region within the specific environment; means for gathering navigation information indicative of perceived movements of the mobile device with regard to the portal, in response to a determination that the mobile device has at least entered the threshold area of the portal; and means for transmitting at least a portion of the navigation information to at least one other device. In certain instances, at least the portion of the navigation information may be indicative of whether the mobile device transitioned from the first region to the second region via the portal.

In accordance with still other aspects, a mobile device may be provided which comprises: a communications interface; and a processing unit to: determine whether the mobile device has at least entered a threshold area of a portal that connects a first region within a specific environment to a second region within the specific environment; gather navigation information indicative of perceived movements of the mobile device with regard to the portal, in response to a determination that the mobile device has at least entered the threshold area of the portal; and initiate transmission of at least a portion of the navigation information to at least one other device via the communications interface. In certain instances, at least the portion of the navigation information may be indicative of whether the mobile device transitioned from the first region to the second region via the portal.

In accordance with yet certain other aspects, an article of manufacture may be provided which comprises: a non-transitory computer readable medium having computer implementable instructions stored therein which are executable by a processing unit of a mobile device to: determine whether the mobile device has at least entered a threshold area of a portal that connects a first region within a specific environment to a second region within the specific environment; gather navigation information indicative of perceived movements of the mobile device with regard to the portal, in response to a determination that the mobile device has at least entered the threshold area of the portal; and initiate transmission of at least a portion of the navigation information to at least one other device. In certain instances, at least the portion of the navigation information may be indicative of whether the mobile device transitioned from the first region to the second region via the portal.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example environment that includes representative electronic devices that may perform and/or otherwise support certain positioning capabilities in a mobile device in accordance with an example implementation.

FIG. 2 is a schematic block diagram illustrating certain features of a computing platform that may be provided in an electronic device, such as a computing device or a server, to support certain positioning capabilities in a mobile device in accordance with an example implementation.

FIG. 3 is a schematic block diagram illustrating certain features of a computing platform that may be provided in an electronic device, such as a mobile device, to perform certain positioning capabilities in accordance with an example implementation.

FIG. 4 is a flow diagram illustrating an example process that may be implemented in whole or in part in an electronic device, such as a computing device, e.g., as in FIG. 2, to support certain positioning capabilities in a mobile device in accordance with an example implementation.

FIG. 5 is a flow diagram illustrating an example process that may be implemented in whole or in part in an electronic device, such as a mobile device, e.g., as in FIG. 3 to support certain positioning capabilities in accordance with an example implementation.

FIG. 6 is a flow diagram illustrating an example process that may be implemented in whole or in part in an electronic device, such as a mobile device, e.g., as in FIG. 3 to support certain positioning capabilities in accordance with an example implementation.

FIG. 7 is a schematic diagram illustrating an example floor plan of a structure comprising at least a first region and a second region connected together by at least one portal through which a mobile device may transition in accordance with an example implementation.

FIG. 8 is a schematic diagram which illustrates an example floor plan wherein a first region and a second region are provisioned on the same level of a structure and connected together by an operatively shared region comprising at least one portal through which a mobile device may transition, in accordance with an example implementation.

FIG. 9 is a schematic diagram which illustrates an example floor plan wherein a plurality of grid points may be associated with all or part of the floor plan and/or a corresponding electronic map and/or the like, in accordance with an example implementation.

FIG. 10 is a schematic diagram which illustrates an example floor plan wherein certain features of the floor plan may be indicated and/or otherwise made identifiable as portals within a particular data set and/or data file in accordance with an example implementation.

FIG. 11 is a schematic diagram which illustrates that certain features of a floor plan may be indicated and/or otherwise made identifiable, e.g., based, at least in part, on one or more user inputs, as portals, in accordance with an example implementation.

FIG. 12 is a schematic diagram which illustrates an example floor plan wherein a plurality of grid points may be associated with all or part of the floor plan and/or a corresponding electronic map and/or the like, in accordance with an example implementation.

FIG. 13 is a schematic diagram which illustrates an example floor plan wherein the identified portals are further associated with applicable, example threshold areas comprising subsets of grid points that may be associated with all or part of the floor plan and/or a corresponding electronic map and/or the like, in accordance with an example implementation.

FIG. 14 is a schematic diagram which illustrates, via defused shading, an example floor plan wherein a subset of grid points within a threshold area of a particular identified portal may be ranked, in accordance with an example implementation.

FIG. 15 is a schematic diagram which illustrates an example floor plan having an inferred portal and/or inferred threshold area associated there with, and which may identify a subset of grid points that may be associated with all or part of the floor plan and/or a corresponding electronic map and/or the like, in accordance with an example implementation.

FIG. 16 is a schematic diagram which illustrates example portals and/or threshold areas associated with certain doorways connecting first and second regions with an operatively shared area, and which may identify particular subsets of grid points in accordance with an example implementation.

### DETAILED DESCRIPTION

Reference throughout this Specification to “a feature,” “one feature,” “an example,” “one example,” and so forth means that a particular feature, structure, characteristic, or aspect, etc. that is described in connection with a feature or example may be relevant to at least one feature or example. Thus, appearances of a phrase such as “in one example,” “for example,” “in one feature,” “a feature,” “a particular feature,” “in an example implementation,” or “for certain example implementations,” etc. in various places throughout this Specification are not necessarily all referring to the same feature, example, or example implementation. Furthermore, particular features, examples, structures, characteristics, or aspects, etc. may be combined in one or more example devices, example methods, example apparatuses, or other example implementations.

As used herein, the term “specific environment” is intended to represent an environment that a mobile device may be transported through and/or moved about within. A mobile device may, for example, be transported and/or moved about by a “user”, such as, e.g., a person, an animal, a machine, etc. As described in greater detail herein, in certain instances a specific environment may comprise at least one region that a user may enter into and/or exit from via at least one portal. Accordingly, in certain instances a specific environment may comprise all or part of one or more indoor spaces and/or one or more outdoor spaces. Thus, for example, in certain instances a specific environment may comprise all or part of one or more floors of a building. In other instances, a specific environment may comprise all or part of a plurality of buildings, which may be interconnected via one or more indoor and/or outdoor regions and/or portals that may be navigated by a user. Thus, for example, a specific environment may comprise all or part of a school campus, all or part of an open air shopping center, all or part of a cruise ship, all of part of an airport, and/or the like.

Accordingly, in certain implementations, a specific environment may be sufficiently large, complex, or otherwise difficult to navigate so that navigational services may be beneficial, e.g., to a user of a mobile device. Hence, a user may benefit from a navigational service, which may involve maps or directions, etc., or another location-based service (LBS) to be provided via a mobile device with regard to all or part of a specific environment. Unfortunately, in contrast with large-scale, outdoor spaces in which road maps or mobile device locations may be made available via e.g. satellite imagery or satellite positioning system (SPS) technologies, maps or mobile device positions within certain specific environments may not be as readily available. For example, satellites cannot merely photograph interior features of a structure, or SPS signals may be too attenuated for use within a structure.

Location-based services may, for example, include positioning, personal machine/pedestrian navigation, mapping, static directions, real-time turn-by-turn directions, or location-based searching (e.g., searching of local points of interest), just to name a few examples. To provide location-based services indoors, one or more local coordinate systems may be established for particular indoor spaces. An indoor space (e.g. a region), for example, may be referred to as a “location context.” A mobile device or a server device may store or associate location context identifiers (LCIs) with specific “location contexts.” A location context may comprise, by way of example but not limitation, a locally-defined environment or other region such as, for example, a particular floor of a building or another indoor region that may not be mapped according to a global coordinate system. A given indoor region or other location context may be associated with at least a portion of at least one local coordinate system, at least a portion of at least one global coordinate system, at least a portion of at least one local coordinate system that may be translated into one or more other local coordinate systems or global coordinate systems, or any combination thereof, etc., just to name a few examples, or may not be associated with any of these. Claimed subject matter is not limited to any particular coordinate system or systems or to any particular location context.

An LCI may, for example, be associated with or identify a particular region of an indoor structure and/or some operative use of such a region. For example, in certain instances, a particular region may comprise all or part of one or more levels (e.g., vertically arranged) in a multilevel structure. Thus, simply taking into account the physical structure itself, in certain instances each floor in an office building may be considered as a different region (e.g., associated with or identifiable by a different LCI).

In other examples, it may be useful to additionally and/or alternatively consider an operative use of all or part of the structure in defining a region. Thus, for example, assume that an office building has three levels, e.g., three floors, in which the first floor comprises a lobby, the second floor and one half of the third floor comprise a first entity (e.g., a first business/tenant), and the remaining one half of the third floor comprises a second entity (e.g., a second business/tenant). Here, for example, it may be beneficial to define: the second floor and one half of the third floor, associated with the first entity, as a first region (e.g., identifiable by a first LCI); the remaining one half of the third floor, associated with the second entity, as a second region (e.g., identifiable by a second LCI); and, possibly the first floor as a third region (e.g., identifiable by a third LCI). Hence, for example, with a mobile device, a visitor to such a building may initially obtain some form of information corresponding to all or part of the lobby (e.g., identifiable by the third LCI). Such a visitor with a mobile device, may subsequently request/obtain some form of information corresponding to all or part of one or more of the remaining regions (e.g., identifiable by other LCI's) within the building. For example, such a mobile device may obtain and process various information from one or more location-based services and/or the like for such regions (e.g., identifiable by applicable LCI's). Such information may comprise any information and/or computer implementable instructions that may be of interest to a user (e.g., the visitor) and/or otherwise of use to one or more functions and/or other like capabilities provided in whole or part by the mobile device. For example, such information may comprise electronic map information, routability graph information, and/or the like which may be of use, at least in part, by a positioning and/or navigation function/capability. For example, such information may comprise information, etc., associated with one or more entities, persons, services, etc., corresponding to one or more regions. For example, such information may comprise data and/or instructions for use and/or presentation of augmented reality information to a user via a display and/or speaker. For example, such information may comprise data and/or instructions for use and/or presentation of advertisements, coupons, solicitations, videos, music, etc., that may be of interest to a user. In certain instances, such information may be provided as part of one or more location-based services, as part of some positioning assistance data, and/or the like.

An LCI may be used to identify at least one location context. An LCI may comprise, by way of example but not limitation, one or more alphabetical characters, one or more numerical characters, or combinations thereof, etc. However, claimed subject matter is not limited to any particular implementation for an LCI. An LCI may be associated with at least one location context. An LCI may also or alternatively be associated with one or more wireless transmitting devices, e.g., of a location context. For example, if a particular LCI is associated with a particular location context, the particular LCI may also be associated with at least one wireless transmitting device corresponding to the particular location context. At least one particular wireless transmitting device may correspond to the particular location context if it is physically located at the particular location context, if it transmits signals that are receivable by a mobile device that is physically located at the particular location context, or any combination thereof, etc., just to name a couple of examples.

A wireless transmitting device may be associated with at least one identity. For an example Wi-Fi access point (AP) and/or other like service based transceiver device implementation of a wireless transmitting device, an identity may comprise a media access control address (MAC address), and/or some other unique identifier, of the Wi-Fi AP, etc. A signal may be received from a Wi-Fi AP or demodulated to acquire a MAC address, and/or some other unique identifier. However, claimed subject matter is not limited to any particular form of identity for a wireless transmitting device. An electronic device, such as a server or other like computing device, or a mobile device, may, for example, store one or more LCIs in association with at least one location context or in association with at least one wireless transmitting device. These may be stored, by way of example only, using one or more databases. If an identity of a wireless transmitting device is ascertained, an LCI that is associated with the ascertained wireless transmitting device identity may be determined from stored associations of wireless transmitting device identities or LCIs. With a determined LCI, a location context that is associated with the determined LCI may be determined from stored associations of LCIs or location contexts. For certain example implementations, an identity of at least one wireless transmitting device may be used to determine an associated LCI, or an LCI may be used to determine an associated location context. Additionally or alternatively, wireless transmitting device identities may be associated with or stored in association with location contexts. In certain example implementations, an identity of at least one wireless transmitting device may be used to determine an associated location context. A particular location context may comprise, by way of example but not limitation, a particular indoor space, a particular floor of a building, any combination thereof, etc.

LCIs may be used as handles for requesting location context characteristics and/or other information, which may be descriptive of a location context. Location context characteristics may, by way of example only, (i) include at least a portion of a schematic map of a location context or (ii) be laid over or linked to at least part of a schematic map of a location context. Location context characteristics for an indoor region implementation may include, by way of example but not limitation, at least a portion of any one or more of the following: a schematic map of an indoor space, a connection or routing graph for an indoor region, routes or paths over a schematic map, points of interest that are local or unique to one or more indoor spaces, locations of wireless transmitting devices of an indoor space, identities of wireless transmitting devices of an indoor space, or any combination thereof, etc., just to name a few examples. However, claimed subject matter is not limited to any particular examples of content comprising characteristics that may be descriptive of a location context.

A mobile device may use at least one LCI to obtain an electronic map (e.g., a schematic map, routability graph etc.) of an indoor space or identification of wireless transmitting devices of an indoor space, for example. By way of example only, a mobile device may send a request including or otherwise specifying an LCI to a server device storing or otherwise having access to location context characteristics. Additionally or alternatively, a mobile device may use a particular LCI to obtain characteristics corresponding to particular location context that is to be used in an application connected to the particular location context. For example, a mobile device may obtain particular location context characteristics for use in an indoor pedestrian navigation application that is operable in connection with the particular location context. Such obtained characteristics may include a schematic map that provides or enables a display of, for example, corridors, rooms, hallways, doors, entry ways, restrooms, portals between different areas, points of interest, or any combination thereof, etc. of an indoor space. A schematic map for an indoor space may be used to facilitate navigation within an indoor space. For an example navigational application, metadata corresponding to a schematic map may define a routing topology set out in a coordinate system that is local to a particular location context, as distinguishable from a global coordinate system.

A mobile device may also use one or more LCIs to obtain point of interest (POI) features for a given indoor space of a particular location context. POI features may include, by way of example only, description or identification of particular locations or potential destinations of an indoor space. Examples of POI features may include, but are not limited to, names of stores; locations of restrooms; names of office inhabitants; locations of copier or break rooms; purposes of rooms; identifications of stairs, escalators, or elevators; identifications of points of ingress or egress; or any combination thereof; etc.

Use of characteristics that are descriptive of a location context may depend, at least partially, on a position of a mobile device within an indoor space. Unfortunately for users located within specific environments, as is explained further below, performing a positioning operation to estimate a position of a mobile device may be more difficult indoors as compared to outdoors.

While several of the preceding examples regarding location based services, location context(s) and LCIs are illustrated with respect to indoor spaces, it should be understood that such may also be provided with respect to all or part of one or more specific environments. Thus, in certain instances, certain location based services, location context(s), LCIs, and/or the like may be used for or otherwise correspond to all or part of one or more indoor and/or outdoor spaces.

As indicated above, electronic map-based positioning or other navigational services in some outdoor environments may be effectuated using positioning fixes obtained via SPS signals or using signals transmitted from one or more terrestrial cellular base stations or similar fixed outdoor transmitting stations. Within some specific environments (e.g., comprising indoor spaces, urban canyons, etc.) on the other hand, SPS signals may often be too weak or undetectable. Likewise, with regard to signals transmitted from terrestrial base stations, a mobile device may, at times, acquire an insufficient number of signals and/or too many signals lacking sufficient signal strength. Consequently, positioning strategies that are effective in some outdoor environments may be inadequate for certain specific environments. To combat these difficulties, indoor or other like local positioning for mobile devices may be effectuated at least partly by processing signals transmitted from wireless transmitting devices that are located, for example, within a specific environment. Wireless transmitting devices may include, but are not limited to, wireless transmitters that comport with a Wi-Fi AP protocol (e.g., IEEE 802.11), a Bluetooth protocol, a femtocell protocol, or any combination thereof, etc.

To employ a wireless transmitting device for a floor determination operation, a mobile device may use an estimated location or an identity of a wireless transmitting device. An identity of a wireless transmitting device may be ascertained by receiving or demodulating at least one signal transmitted by a wireless transmitting device. Reception or demodulation of signals may consume resources. Resources that are consumed may include, by way of example only, time, power, bandwidth, or any combination thereof, etc. If a mobile device performs a scanning operation to ascertain an identity of a wireless transmitting device, additional resources may be consumed as multiple signals, which may be propagating on multiple frequencies, are received or demodulated. For example, a finite amount of time may elapse while a mobile device is scanning transmissions to identify a wireless transmitting device. Also, battery life may be consumed to power reception and processing of signals emanating from wireless transmitting devices. Furthermore, at least a portion of available wireless bandwidth may be consumed by scanning to receive or demodulate signals that are emanating from wireless transmitting devices in order to provide indications of their identity.

Consequently, it may be beneficial to reduce such scanning operations to conserve resources. In accordance with certain aspects, the techniques provided herein may reduce such scanning operations through the use of at least one portal transition parameter which may be based, at least in part, on a likelihood that a mobile device, if located in a first region and within a threshold area of a portal, may or may not transition from the first region to a second region through such interconnecting portal. As described in greater detail herein, such a likelihood may be based, at least in part, on a gathered history of mobile devices, e.g., with regard to their movements within at least the first region and more specifically within a threshold area of such a portal. Accordingly, in certain implementations, a mobile device that may be located within such a threshold area may determine a likelihood as to whether it may or may not transition from the first region to the second region through the portal based, at least in part, on the portal transition parameter. Hence, such a determined likelihood may, for example, affect operation of an application for selecting an LCI from among a plurality of LCIs, active scanning of wireless signals, etc. For example, if it is unlikely that a mobile device is to transition from the first region to the second region through the portal, then the mobile device may refrain from selecting an LCI for the second region, requesting/receiving additional information regarding the second region, and/or performing active scanning for wireless signals, etc. Conversely, for example, if it is more likely that a mobile device is to transition from the first region to the second region through the portal then the mobile device may select an LCI for the second region, possibly request/receive additional information regarding the second region, and/or perform active scanning for wireless signals, etc. In some embodiments, such operations are performed prior to the mobile device transitioning from the first region to the second region such that information associated with the second region is immediately available to the mobile device when the mobile device arrives at the second region.

As described in greater detail below, in certain example implementations, a computing platform, e.g., in a server or mobile device other computing device may identify a portal connecting a first region within a specific environment and a second region within the specific environment. Here, for example, such a portal may be identified based, at least in part, on an electronic map corresponding to at least a portion of the specific environment. A corresponding portal transition parameter may be computed based, at least in part, on a likelihood that a mobile device, if located in the first region and within a threshold area of the portal, may or may not transition from the first region to the second region through the portal. Here, for example, such a likelihood may be based, at least in part, on a gathered history of mobile devices in the first region and within the threshold area of the portal. In certain implementations, one or more such portal transition parameters may be transmitted to one or more mobile devices. In certain implementations a threshold area of a portal may be determined based, at least in part, on one or more of: at least one user input parameter corresponding to an electronic map, an identifier and/or the like associated with at least one feature encoded within an electronic map, and/or identifying locations where users transition from one region and/or LCI to another. Thus, in certain implementations, a portal and/or a threshold area of such a portal may be inferred based, at least in part, on gathered history. Here, for example, in inferred portal/threshold area may be determined to exist even though no corresponding feature or other indication for such a portal appears in an electronic map. Thus, for example, if a new portal is provided within a structure and used by people carrying mobile devices, a gathered history based on navigation information provided by such mobile devices may be indicative of such a new portal/threshold area.

As described in greater detail herein, in certain example implementations a computing platform may identify a subset of grid points within a plurality of grid points corresponding to an electronic map as representing a threshold area of a portal. In certain further example implementations, two or more of such grid points may be ranked based, at least in part, on a perceived significance of at least one feature encoded within an electronic map as representing an available portal within a specific environment, and a subset of grid points may be based, at least in part, on such a ranking. For example, in certain instances a subset of grid points may be clustered together, e.g., via a clustering algorithm and/or the like, to identify a threshold area of a portal. In certain example implementations, such grid points may be provided as part of a routability graph corresponding to at least a portion of an electronic map.

As previously mentioned, in certain example implementations, a first region may be identifiable by a first LCI and a second region may be identifiable by a second LCI which is different from the first LCI. Thus, in certain example implementations, in computing a portal transition parameter a computing platform may calculate and consider a probability that a user transporting a mobile device and located within a threshold area of the portal may or may not remain within the first LCI. Alternatively, or in addition, in certain example implementations, a computing platform may calculate and consider a probability that a user transporting a mobile device and located within the threshold area of the portal may or may not transition from the first LCI to the second LCI using the portal. In calculating these probabilities, the computing device may compute a probability of the mobile device entering or taking the portal when in the threshold area, and of transitioning once in the portal.

By way of further example, in certain example implementations, a computing platform may calculate and consider a likelihood of a user transporting a mobile device using a portal to transition from one region to one or more other regions. For example, many users entering a bottom floor of a building having elevators may take the elevators to reach other floors. Accordingly, in certain example implementations, it may be beneficial for a computing platform to determine a likelihood of a user transporting a mobile device using the elevator(s) as a portal based, at least in part, on certain differences in the location context of the various floors. Thus, for example, a computing platform may consider a type and/or a density of certain points of interest on one or more of the floors, e.g., as a user enters the bottom floor, or some other floor. In certain instances, as described herein, a gathered history may be considered which provides certain traffic statistics information (e.g., collected by a crowd sourcing server, stationary camera, volunteer mobile devices, etc.). In certain instances, a portal transition parameter based, at least in part, on such a likelihood may be determined and possibly provided in advance (preemptively) to a mobile device.

In certain example implementations, a computing platform may calculate and consider a likelihood of a user transporting a mobile device transitioning to a particular region based, at least in part, on information about the applicable portals which may or may not lead to the particular region. For example, in a building having a plurality of floors, a bottom floor (e.g., a lobby level, a street level access, a subway level access, a parking garage access, etc.) of such a building may have a higher likelihood of a user transitioning to it from the other floors, particularly at certain points in time (e.g., near the end of a work day). For example, it may be more likely that a user on the sixth floor of such a building will transition to the bottom floor via the elevators than to the ninth floor, or third floor. In some embodiments, a likelihood of transitioning to a given floor (or other region) may be based on a number of POI features located on that floor (or in that region). Probabilities of transitioning may be based on crowdsourced measurements in some embodiments. Such crowdsourced measurements may be combined with other metrics such as the number of POI features, or transition probabilities determined based on characteristics or a priori knowledge of an environment (for example, number of floors of a building, and number of employees or offices on each floor). Note that each portal may comprise a different set of probabilities, for example based on the number of regions the portal connects and/or characteristics of the portal. For example, users may be more likely to use a set of stairs to go up or down one or two floors than to climb five or six floors, and an emergency portal may predominantly be used to move to an exit. In certain instances, a portal transition parameter based, at least in part, on a likelihood as discussed above may be determined and possibly provided in advance (preemptively) to a mobile device.

In certain example implementations, in computing a portal transition parameter a computing platform may consider one or more points of interest that may be identified in the electronic map within a first region or a second region. Here, for example, a likelihood that a mobile device may transition from a first region to a second region may be affected by one or more points of interests (e.g., to the user of the mobile device) which may be located in a particular region. Further, the likelihood may be affected by a potential route, viability of different routes, traffic, obstacles, etc., which may be traversed to reach the one or more points of interest.

In certain example implementations, in computing a portal transition parameter a computing platform may consider a type of the portal (e.g., staircase, elevator, etc.), an operational feature of the portal (e.g., whether a staircase is intended for normal use or emergency use, etc.), an identifiable feature of the mobile device (e.g., whether some physical and/or operative feature of the mobile device prevents or promotes use of one portal over another and/or one region over another, etc.), a user preference (e.g., whether a user prefers use of a certain portal over another and/or one region over another, etc.), a perceived level of use of the portal (e.g., based on at least a portion of the gathered history, etc.), and/or the like or some combination thereof.

In certain instances, a specific environment may comprise a first structure with at least a first region, a second structure with at least a second region; and a portal connecting the first and second regions (e.g., through which a mobile device may transition at least from the first region to the second region and/or from the second region to the first region). Here for example, a portal may comprise a walkway or bridge interconnecting the first region in the first structure with the second region in the second structure.

In certain instances, a specific environment may comprise a structure having at least two levels, and a first region and a second region may be located therein on different levels. Here, for example, a portal may connect at least the two regions together. For example, a portal may comprise a staircase, an escalator, an elevator, a ramp, etc. In certain instances, the two levels may be adjacent to one another, while in other instances, the two levels may be separated by one or more other levels and/or objects. Accordingly, in certain implementations, certain portals may connect three or more regions together. For example, one or more elevators may interconnect a plurality of levels in an office building, one or more interconnected hallways may interconnect a plurality of office suites in a building, and/or one or more bridges indoor walkways may interconnect a plurality of regions in a plurality of interconnected structures, just to name a few examples.

As mentioned, in certain instances, a first region may be operatively associated with a first entity and a second region may be operatively associated with a second entity. Hence, in certain instances, a portal may comprise a feature of a specific environment that may be operatively shared by the first entity and the second entity. For example, a portal may comprise all or part of a lobby and/or other like hallways, etc., within a floor of a building that may be operatively shared by a first entity in a first suite and a second entity and a second suite, wherein each of these entities/suites may be associated with different regions/LCI's.

As described in greater detail herein, a computing platform may affect (e.g., establish, modify, update, maintain, etc.) a gathered history based, at least in part, on navigation information indicative of perceived movements of at least one mobile device within at least one of the first region or the second region. Thus, for example, in certain implementations, a computing platform may transmit a request for such navigation information to one or more mobile devices, e.g., possibly as part of a crowd-source operation, etc. In certain implementations, a mobile device may transmit such navigation information to the computing platform in response to determining that the mobile device has transitioned from one region to another region. As described in greater detail below, a computing device may, identify the presence of a previously unknown portal based, at least in part, on such a gathered history. Hence, for example, a computing platform may affect the gathered history based, at least in part, on a reported transition from a first region to a second region of at least one mobile device without using at least one previously identified portal connecting the first region to the second region.

As described in greater detail herein, a mobile device may receive a portal transition parameter corresponding to at least a portion of an electronic map of a specific environment. Here, for example, such a portal transition parameter, which may be received from a computing platform and/or other like intervening devices, may correspond to a threshold area of a portal from a first region within the specific environment to a second region within the specific environment. A mobile device located within the threshold area of the portal may determine a likelihood as to whether or not it may transition from the first region to the second region through the portal based, at least in part, on the portal transition parameter. Here, for example, such a portal transition parameter may be based, at least in part, on a gathered history of mobile devices in the first region and within the threshold area of the portal. Furthermore, as described in greater detail, in certain implementations, a mobile device may estimate its current state including at least its estimated location, e.g., in a first region that may be identifiable by a first LCI, associate its current state with a portal, and affect operation of an application for selecting an LCI from among a plurality of LCIs responsive, at least in part, to such a determined likelihood. In certain instances, such an application may comprise an active scanning of wireless signals. In certain instances, a mobile device may transmit a request for such a portal transition parameter to one or more other devices. In certain instances, a mobile device may selectively transmit, e.g. based on such a determined likelihood, a request for positioning information corresponding to at least one LCI. In certain instances, a mobile device may transmit navigation information indicative of perceived movements of the mobile device within at least one of the first or second regions. For example, perceived movements may be obtained based, at least in part, on one or more wireless signals received from one or more transmitting devices, one or more sensors on board the mobile device (e.g., one or more inertial sensors, and/or one or more environmental sensors), one or more user inputs, and/or the like or some combination thereof. In certain instances, a mobile device may receive a request for navigation information from at least one other device.

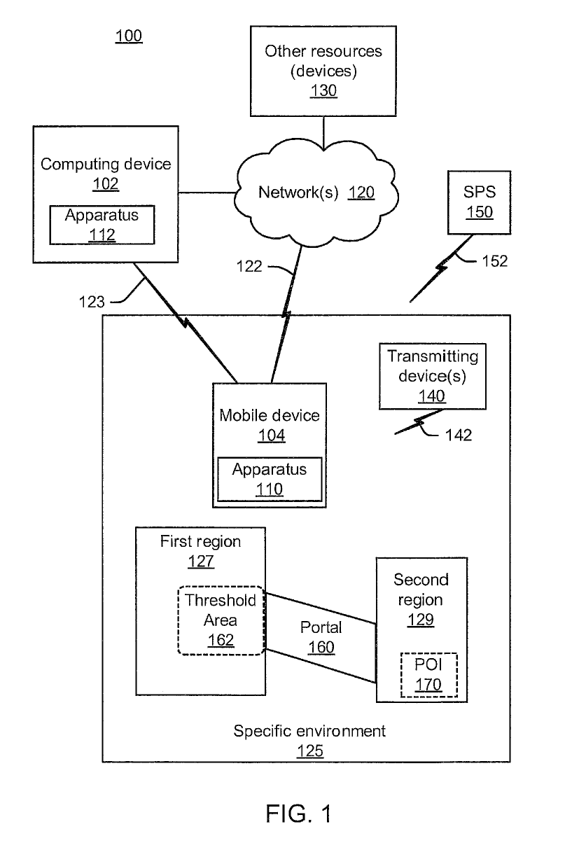

With this introduction in mind, attention is drawn first to FIG. 1, which is a schematic block diagram illustrating an example environment 100 that includes representative electronic devices that may perform and/or otherwise support certain positioning and/or other like navigation capabilities in a mobile device 104, for example based, at least in part, on at least one portal transition parameter. A portal transition parameter may, for example, comprise or otherwise be based, at least in part, on a determined likelihood that mobile device 104, if located in a first region 127 of a specific environment 125 and within a threshold area 162 of a portal 160 connecting first region 127 to a second region 129 of specific environment 125, may or may not make use of portal 160 to transition from first region 127 to second region 129 through portal 160. It should be understood that, in certain instances, a threshold area may partially overlap or completely encompass a portal (e.g., when a portal comprises an elevator). Additionally, it should be understood that a portal may be associated with a specific threshold region in each of the regions connected by the portal. Thus, each floor that an elevator stops at may comprise its own threshold area. Moreover, in certain instances, such threshold areas may differ from one another.

In this example, the representative electronic devices may include mobile device 104, computing device 102, other resources (devices) 130, and network(s) 120. In this example all of the representative electronic devices, except mobile device 104, are illustrated as being located outside of specific environment 125. In other example implementations, one or more of the other the representative electronic devices may be located within specific environment 125, one or more other specific environments (not shown), or external thereto. As illustrated in various examples herein, such representative electronic devices may, for example, provide support for various forms of communication and/or computing capabilities to mobile device 104. More particularly, in certain instances such representative electronic devices may exchange information with mobile device 104 to aid in positioning and/or other like navigation capabilities that mobile device 104 may benefit from. For example, in certain instances a mobile device may obtain location context information, electronic map(s), navigation/positioning assistance data, and/or the like for all or part of one or more specific environments which may be useful to a user at some point in time (e.g., when entering into, exiting from, and/or moving about within the specific environment). In certain examples, a mobile device may also interact with such representative electronic devices to support certain capabilities provided by one or more of such representative electronic devices. For example, mobile device 104 may provide information regarding its movements or lack thereof with regard to a specific environment for use in a history gathering and/or other like crowd source based operation. Hence, in certain example implementations such representative electronic devices may comprise all or part of: a location server and/or map directory, which may, for example, provide an address or URL of one or more servers or other computer devices—the servers or other computing devices may comprise a location or map or indoor positioning assistance server and/or a map inference server in some embodiments—from which a device may retrieve a map near to or associated with an approximate location; a location or map or indoor positioning assistance server and/or a map inference server, which may, for example, provide assistance data and/or maps and/or position models such as WiFi and/or RSSI models and/or positions of associated devices such as APs; a crowdsourcing server, which may, for example, collect data to adjust the information provided by the location or map or indoor positioning assistance server and/or map inference server; a point of interest server, which may, for example, provide an LBS; a location based service, etc.

As illustrated, various terrestrial-based transmitting devices 140 (e.g., wireless network access points, wireless service transceivers, dedicated positioning beacons, femto and/or pico cell transceivers, etc.) may be operatively provisioned for use by mobile devices navigating within specific environment 125. While illustrated in FIG. 1 as being physically located within specific environment 125, it should be kept in mind that in certain implementations all or part of one or more transmitting devices 140 may be physically attached to or otherwise arranged nearby a structure defining at least a part of specific environment 125. In this example, a transmitting device 140 may represent a transmitting device that is operatively provisioned for use by a mobile device within at least a portion of specific environment 125, which may acquire one or more wireless signals 142.

As further illustrated, one or more satellite positioning system systems (SPS) 150 may be provided to transmit one or more wireless positioning signals in the form of one or more SPS signals 152 that may, at times, be acquired by mobile device 104 and used for positioning and/or navigation purposes. Additional description of such devices as provided herein although the technology is well known.

As shown, computing device 102 comprises an apparatus 112 that may compute one or more portal transition parameters and transmit, directly or indirectly, such portal transition parameter(s) to one or more mobile devices 104. For example, as described in greater detail herein, apparatus 112 may identify portal 160 connecting first region 127 and second region 129 based, at least in part, on an electronic map corresponding to at least a portion of specific environment 125. Apparatus 112 may, for example, compute a portal transition parameter based, at least in part, on a likelihood that a mobile device, if located in first region 127 and within threshold area 162 of portal 160, may or may not transition from first region 127 to second region 129 through (sees e.g. making use of) portal 160. Here, for example, apparatus 112 may determine such a likelihood based, at least in part, on a gathered history of mobile devices in first region 127, and possibly more specifically within a threshold area 162. In certain instances, all or part of such a gathered history may be based, at least in part, on navigation information obtained, directly (sees e.g., wireless communication link 123) or indirectly (e.g., via network(s) 120 and wireless communication link 122), from one or more mobile devices. In certain instances such navigation information may comprise, for example, one or more reported transitions (or lack thereof) between first region 127 and second region 129, possibly by previously unknown portal (not shown). Hence, as described in greater detail herein, apparatus 112 may, under certain conditions, infer the presence of a new portal/threshold area. In certain instances, apparatus 112 may request navigation information from one or more mobile devices, e.g., as part of a crowd sourcing operation and/or the like. It should be understood that, in certain example implementations, mobile device 104 may compute transition parameters based on the maps and/or movements of the mobile device 104 without assistance from computing device 102. In certain instances, certain parameters may additionally be based on information received from computing device 102, for example relating to movement of other mobile devices and/or to combine a transition parameter computed at computing device 102 with a transition parameter computed at mobile device 104. Thus, in some implementations transition parameters may be different for different mobile devices (not all mobile devices may transition with the same probability, but rather may differ, e.g., one user may be more likely to take the stairs while another is more likely to take the elevator).

Apparatus 112 may represent one or more computing platforms that may communicate with one or more other resources (devices) 130, either directly and/or indirectly, e.g. via one or more network(s) 120. Apparatus 112 may communicate with mobile device 104, either directly (e.g., via wireless communication link 123) and/or indirectly (e.g., as illustrated using network(s) 120 and wireless communication link 122). Again, while computing device 102 happens to be illustrated in this example as being located outside of specific environment 125, it should be recognized that in certain other implementations, all or part of computing device 102 and/or apparatus 112 may be located within specific environment 125. In some embodiments, computing device 102 comprises a server located behind a WLAN comprising the transmitting device 140. In some such embodiments, the computing device 102 acts as a controller for the WLAN. For example, the transmitting device 140 may be in communication with the network 120, which comprise a LAN in some embodiments.

Network(s) 120 may comprise one or more communication systems and/or data networks having various interconnected devices supporting communication between computing device 102 and one or more other resources (devices) 130. As mentioned, network(s) 120 may further support communication between computing device 102 and mobile device 104. For example, communication between computing device 102 and mobile device 104 may allow for certain data and/or instructions to be exchanged there between.

As used herein a “mobile device” may represent any electronic device that may be moved about either directly or indirectly by a user in at least specific environment 125 and which may communicate with one or more other devices via one or more wired and/or wireless communication links. Some examples include a cell phone, a smart phone, a computer (e.g., a personal computer such as a laptop computer, tablet computer, a wearable computer, etc.), a navigation aid, a tracking device, a digital book reader, a gaming device, music and/or video player device, a camera, a machine, a robot, etc.

Other resources (devices) 130 may represent one or more computing platforms from which computing device 102 and/or mobile device 104 may obtain certain data files and/or instructions, and/or to which computing device 102 and/or mobile device 104 may provide certain data files and/or instructions. For example, in certain instances, all or part of an electronic map and/or the like for at least a portion of specific environment 125, may be obtained by computing device 102 and/or mobile device 104 from one or more other resources (devices) 130. For example, in certain instances, all or part of a set of instructions for use in apparatus 112 and/or apparatus 110 may be obtained from other resources (devices) 130.

As mentioned, SPS 150 may transmit one or more SPS signals 152 to mobile device 104. SPS 150 may, for example, represent one or more global navigation satellite system (GNSS), one or more regional navigation satellite systems, and/or the like or some combination thereof. Additionally, one or more terrestrial-based indoor positioning systems may be provided as represented by example transmitting device(s) 140 capable of transmitting one or more wireless signals 142 all or some of which may be used for signal-based positioning within specific environment 125. Thus for example, transmitting device(s) 140 may represent a wireless access point, a wireless service transceiver device, a repeater, a dedicated beacon transmitting device, just to name a few examples, which have known positions. Wireless signals 142, and possibly SPS signals 151, may, at times, be acquired by mobile device 104 and used to estimate its position within specific environment 125.

In certain implementations, a mobile device 104 may receive or acquire SPS signals 152 from SPS satellites (not shown). In some embodiments, SPS satellites may be from one GNSS, such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one of several regional navigation satellite systems (RNSSs) such as, for example, WAAS, EGNOS, QZSS, just to name a few examples.

In certain implementations, mobile device 104 may transmit radio signals to, and receive radio signals from, a wireless communication network (e.g., represented by network(s) 120). In one example, mobile device may communicate with a cellular communication network (e.g., represented by network(s) 120) by transmitting/receiving wireless signals, e.g., over wireless communication links 122, to/from a base station transceiver or the like. Similarly, mobile device 104 may receive wireless signals 142 from one or more transmitting devices 140. In certain instances, mobile device 104 may also transmit wireless signals to one or more transmitting devices 140.

In a particular example implementation, mobile device 104 and/or computing device 102 may communicate with each other and/or other resources (devices) 130 over network(s) 120. As mentioned, network(s) 120 may comprise any combination of wired or wireless links. In a particular implementation, network(s) 120 may comprise an Internet Protocol (IP) infrastructure and/or the like, which may be capable of facilitating communication between mobile device 104, computing device 102 and/or other resources (devices) 130. In another example implementation, network(s) 120 may comprise cellular communication network infrastructure such as, for example, a base station controller or master switching center to facilitate mobile cellular communication with mobile device 104.

In particular implementations, and as discussed below, mobile device 104 may have circuitry and processing resources capable of computing a position fix of mobile device 104. For example, mobile device 104 may compute a position fix based, at least in part, on pseudorange measurements to one or more SPS satellites. Here, mobile device 104 may compute such pseudorange measurements based, at least in part, on pseudonoise code phase detections in signals 152 acquired from one or more SPS satellites. In particular implementations, mobile device 104 may receive SPS navigation assistance data that may aid in the acquisition of SPS signals 152 transmitted by SPS 150 including, for example, almanac, ephemeris data, Doppler search windows, just to name a few examples. In certain implementations, a position fix obtained based, at least in part, on SPS signals 152 and/or other like wireless signals may be used as an initial estimated position (e.g., a rough position estimate) of mobile device 104 at the subsequent point in time.

In other implementations, mobile device 104 may obtain an initial estimated position by processing signals received from one or more cellular network transmitting devices and/or the like having known positions (e.g., such as base station transceiver, etc.) using any one of several techniques such as, for example, advanced forward trilateration (AFLT), observed time difference of arrival (OTDOA), etc. In certain example implementations, a range from mobile device 104 may be measured to a plurality of such cellular network transmitting devices, e.g., based, at least in part, on pilot signals transmitted by the cellular network transmitting devices from their known locations and received at mobile device 104. In certain instances, computing device 102, network(s) 120, and/or other resources (devices) 130 may be capable of providing certain forms of cellular network navigation assistance data to mobile device 104, which may include, for example, locations and identities of base transceiver stations, etc., to facilitate certain positioning techniques that might use cellular network signals. For example, a base station almanac (BSA) which indicates locations and identities of cellular base stations in a particular region or regions.

In particular environments, such as specific environment 125, mobile device 104 may not be capable of acquiring signals from a sufficient number of SPS satellites and/or from a sufficient number of cellular network transmitting devices to effectively perform the requisite processing to efficiently compute an updated estimated position. However, as presented by various examples herein, mobile device 104 may be capable of computing a position fix based, at least in part, on one or more wireless positioning signals 142 acquired from transmitting devices 140 (e.g., WLAN access points positioned at known locations, repeaters, extenders, etc.). For example, mobile device 104 may obtain a position fix by measuring ranges to one or more wireless access points which are positioned at known locations for use in a specific environment 125. Such ranges may be measured, for example, by obtaining a MAC address from signals received from such access points and obtaining range measurements to the access points by measuring one or more characteristics of one or more signals received from such access points such as, for example, received signal strength (RSSI) or round trip time (RTT). In certain example implementations, mobile device 104 may obtain an estimated position by applying characteristics of acquired signals to a radio heatmap, probability heatmap, and/or the like or some combination thereof indicating expected RSSI and/or RTT signatures at particular locations within specific environment 125.

As illustrated, mobile device 104 may comprise an apparatus 110 which may obtain a portal transition parameter, e.g., from apparatus 112 in a computing device 102. Here, for example, such a portal transition parameter may correspond to threshold area 162 of portal 160 connecting first region 127 and second region 129. In certain example implementations, apparatus 110 may determine an indicator of a likelihood as to whether the mobile device, if located within threshold area 162, is more or less likely to transition from first region 127 to second region 129 via portal 160. Such a determination may, for example, be based, at least in part, on the portal transition parameter. Apparatus 110 may further affect one or more applications and/or other operations/functions based, at least in part, on such determined likelihood. In certain implementations, apparatus 110 may request certain information, such as, e.g. a portal transition parameter, from one or more other devices.

In certain example implementations, apparatus 110 may, for example, determine whether or not it has at least entered threshold area 162, and in response to such a determination initiate obtaining or otherwise gathering navigation information indicative of perceived movements of mobile device 104, e.g., at least with regard to portal 160 and/or threshold area 162. For example, navigation information may be indicative as to whether mobile device 104 may or may not remain within first region 127 and/or may or may not transition, via portal 160 second region 129. Apparatus 110 may, for example, initiate transmission of at least a portion of the gathered navigation information to at least one other device, e.g. such as apparatus 112 in computing device 102. In certain implementations, apparatus 110 may receive a request for certain information, such as, e.g. gathered navigation information, etc., from one or more other devices.

As further illustrated in FIG. 1, specific environment 125 may comprise at least one point of interest (POI) 170, which in this example is shown within second region 129. POI 170 may be representative of any feature, service, entity, object, person, etc., which may, at times, be of interest to a user (e.g., a person) of mobile device 104. Accordingly, POI 170 may be considered in determining the likelihood as to whether or not a mobile device associated with such a user may or may not transition via portal 160. In certain implementations, one or more user preferences and/or user inputs may be indicative of certain points of interest to a particular user and/or class/group of users. In certain implementations, navigation information and/or gathered history may be indicative of certain points of interests to particular user and/or class/group of users. In certain implementations, all or part of the gathered history of the plurality of mobile devices may be indicative of certain points of interests to one or more users and/or classes/groups of users. In certain implementations, a type of the mobile device and/or other like information may be indicative of certain points of interests for a mobile device. Further, traffic, traffic patterns, time of day, or other factors may be considered in determining the likelihood. For example, a likelihood of transitioning to a break area or cafeteria may be higher around lunchtime.

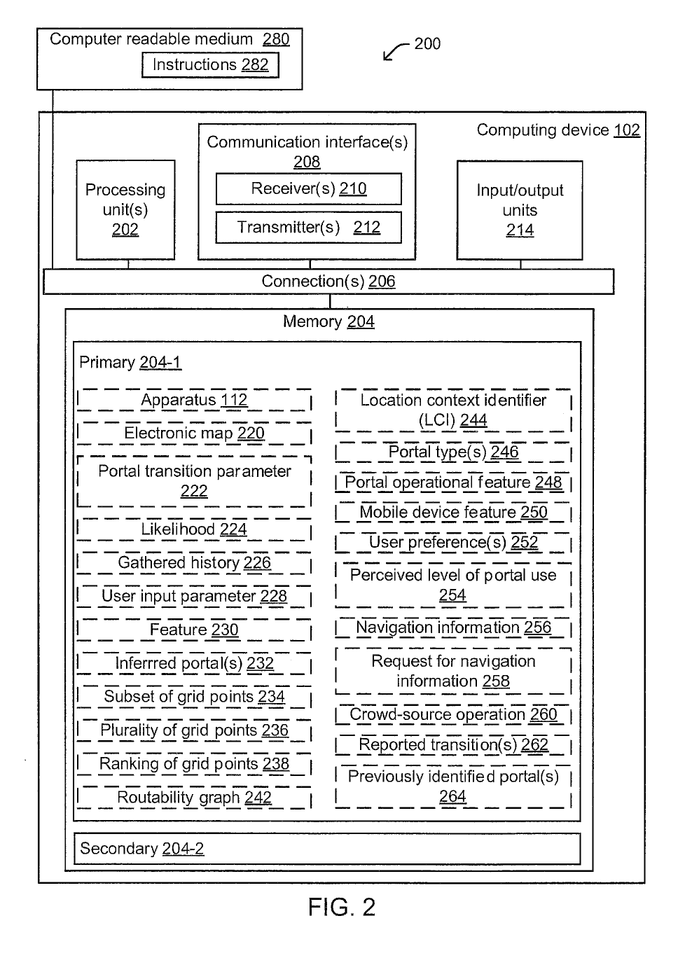

Attention is drawn next to FIG. 2, which is a schematic block diagram illustrating certain features of a computing platform 200 that may be provided in an electronic device, such as computing device 102, to support certain positioning capabilities in a mobile device based, at least in part, by computing at least one portal transition parameter 222, in accordance with an example implementation. Items illustrated in FIG. 2 with dashed-lines may be omitted in some embodiments.

As illustrated computing platform 200 may comprise one or more processing units 202 to perform data processing (e.g., in accordance with the techniques provided herein, as part of apparatus 112, etc.) coupled to memory 204 via one or more connections 206 (e.g., conductors, buses, fibers, etc.). Processing unit(s) 202 may, for example, be implemented in hardware or a combination of hardware and software. Processing unit(s) 202 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co-located/coupled with processing unit(s) 202, or other like circuitry within computing platform 200. Secondary memory 204-2 may comprise, for example, the same or similar type of memory as primary memory and/or one or more data storage devices or systems, such as, for example, a disk drive, an optical disc drive, a tape drive, a solid motion state memory drive, etc.

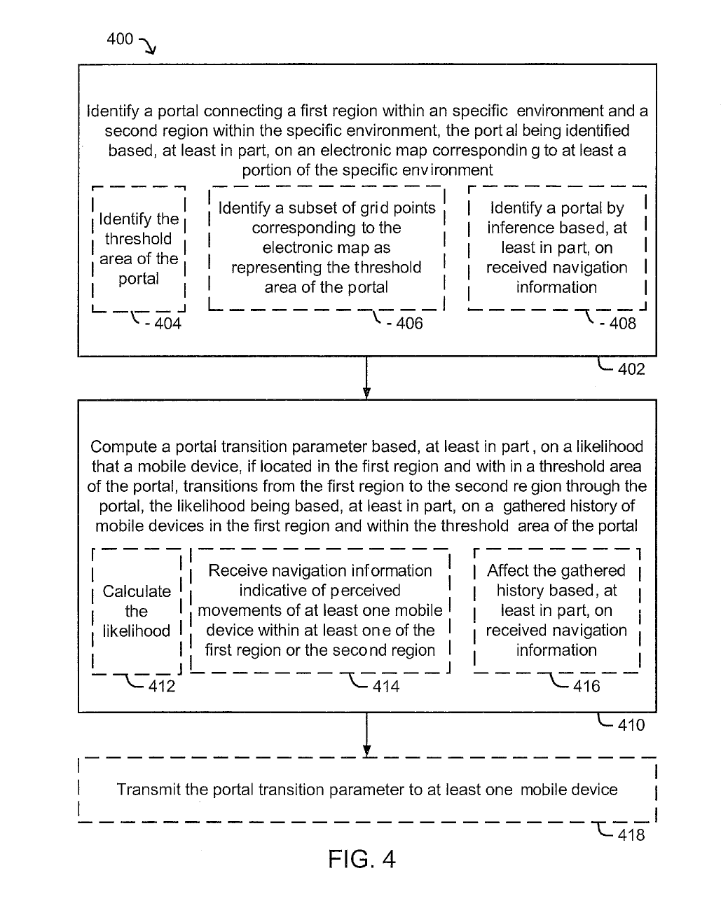

In certain implementations, secondary memory may be operatively receptive of, or otherwise configurable to couple to, a non-transitory computer readable medium 280. Memory 204 and/or non-transitory computer readable medium 280 may comprise instructions 282 for use in performing data processing, e.g., in accordance with the techniques and/or example apparatus 112 (FIG. 1), and/or all or part of example process 400 (FIG. 4) as provided herein.

Computing platform 200 may, for example, further comprise one or more communication interface(s) 208. Communication interface(s) 208 may, for example, provide connectivity to network(s) 120, mobile device 104, and/or other resources (devices) 130 (FIG. 1), e.g., via one or more wired and/or wireless communication links. As illustrated here communication interface(s) 208 may comprise one or more receiver(s) 210, one or more transmitter(s) 212, and/or the like or some combination thereof. Communication interface(s) 208 may implement one or more communication protocols as may be required to support one or more wired and/or wireless communication links.

Computing platform 200 may, for example, further comprise one or more input/output units 214. Input/output units 214 may represent one or more devices or other like mechanisms that may be used to obtain inputs from and/or provide outputs to one or more other devices and/or a user of a computing device 102. Thus, for example, input/output units 214 may comprise various buttons, switches, a touch pad, a trackball, a joystick, a touch screen, a microphone, a camera, and/or the like, which may be used to receive one or more user inputs. For example, in certain implementations, one or more user inputs may be obtained via a graphical user interface (GUI) and/or other like capability which allows a user to view all or part of an electronic map and/or related information associated with a specific environment and interact with such visible display via a mouse, a trackball, etc., in some manner. Here, in particular example, a user may view a schematic diagram of a floor plan of a structure in a specific environment via a display (e.g. an input/output unit 214). Here, in this example, such a user may further selectively apply an indication to certain features and/or objects in the displayed schematic diagram to indicate that the feature and/or object is or is not a portal. For example, as illustrated by way of further example herein, a displayed schematic diagram may include one or more elevators which may be marked or otherwise indicated by a user using an input/output unit 214 as representing a portal between two or more regions. Apparatus 112 may, for example, affect an electronic map and/or other like data file, and/or establish new or further metadata and/or data files which may be indicative of such identified portals. Some additional examples for indicating portals via a user input (e.g. manually) or in an automated manner, e.g., via programmed map extraction/analysis functionality as part of apparatus 112, are provided in subsequent sections. In certain instances, in addition to producing a visual output, input/output units 214 may comprise various devices that may be used in producing an audible output and/or a tactile output for a user.

Processing unit(s) 202 and/or instructions 282 may, for example, provide or otherwise make use of one or more signals that may be stored in memory 204 from time to time and which may represent data and/or instructions, such as: instructions 282; apparatus 112; one or more portal transition parameters 222 (e.g., a probability, a value, a function, a subset of grid points, a set of ranked grid points, grid point rankings, a threshold area measurement, etc.); one or more indicators of likelihood 224 (e.g., a probability, a value, a function, etc.); gathered history 226 (e.g., corresponding to navigation information and/or other reported transition information from one or more mobile devices, crowd-sourced information, etc.); one or more user input parameters 228 (e.g., corresponding to an electronic map and/or the like); one or more features 230 (e.g., corresponding to an electronic map and/or the like); one or more inferred portals 232 and/or corresponding threshold areas; one or more subsets of grid points 234 (e.g., corresponding to an electronic map, routability graph, and/or the like); a plurality of grid points 236 (e.g., corresponding to an electronic map, routability graph, and/or the like); a ranking of grid points 238 (e.g., associated with an identified and/or inferred portal, and/or corresponding to an electronic map, routability graph, and/or the like); a routability graph 242; one or more location context identifier(s) (LCI(s)) 244; one or more portal types 246; one or more portal operational features 248; one or more mobile device features 250; one or more user preferences 252 (e.g., based on mobile device user inputs, gathered history, etc.); a perceived level of portal use 254 (e.g., based on gathered history); navigation information 256 (e.g., associated with one or more mobile devices); one or more requests for navigation information 258 (e.g., associated with a crowd sourcing operation, etc.); a crowd sourcing operation capability 260; one or more reported transitions 262 (e.g., associated with one or more identified and/or inferred portals); one or more previously identified portals 264; and/or the like or some combination thereof. It should be kept in mind, that in certain example implementations, some types of data may comprise or otherwise be represented at least in part by one or more functions and/or other like computer implementable instructions, e.g., which may be used to calculate certain data values, etc. It should be understood that one or more of these data/information elements may be optional and as such omitted in certain implementations.

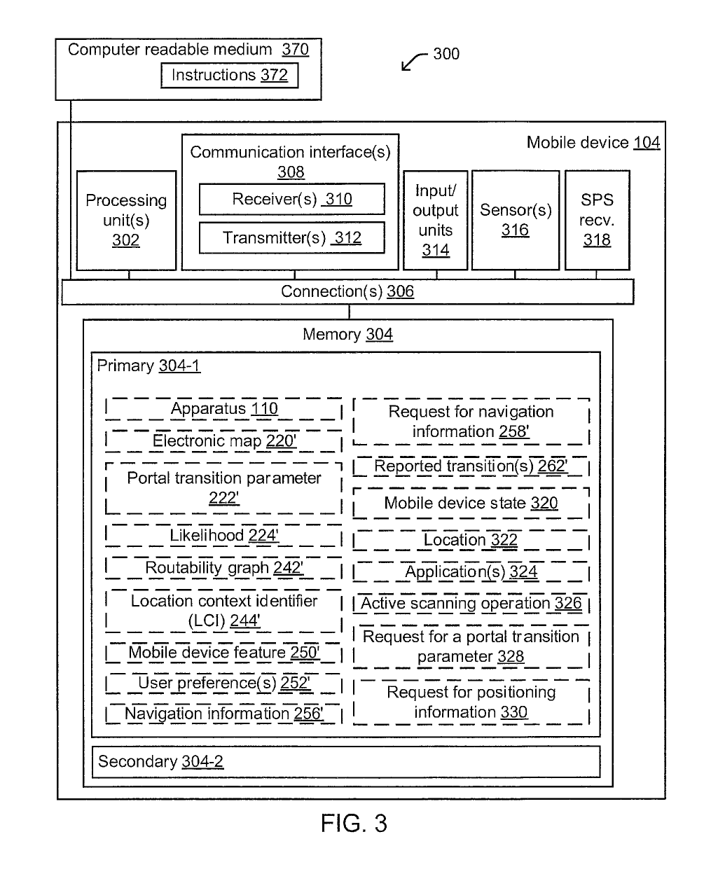

Attention is drawn next to FIG. 3, which is a schematic block diagram illustrating certain features of a computing platform 300 that may be provided in an electronic device, such as a mobile device 104, to perform certain positioning capabilities based, at least in part, on at least one portal transition parameter 222 (see FIG. 2), in accordance with an example implementation. As noted below, in FIG. 3, such a portal transition parameter is referenced as portal transition parameter 222□ to indicate that, in certain implementations, a portal transition parameter 222 as illustrated stored in the primary memory 204-1 of a computing device 102 may or may not be stored exactly the same way and/or in the same format as might portal transition parameter 222□ be stored in the primary memory 304-1 of mobile device 104. Items illustrated in FIG. 3 with dashed-lines may be omitted in some embodiments.

As illustrated computing platform 300 may comprise one or more processing units 302 to perform data processing (e.g., in accordance with the techniques provided herein, and/or apparatus 110, etc.) coupled to memory 304 via one or more connections 306 (e.g., conductors, buses, fibers, etc.). Processing unit(s) 302 may, for example, be implemented in hardware or a combination of hardware and software. Processing unit(s) 302 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 304 may be representative of any data storage mechanism. Memory 304 may include, for example, a primary memory 304-1 and/or a secondary memory 304-2. Primary memory 304-1 may comprise, for example, a random access memory, read only memory, etc. While illustrated in this example as being separate from the processing units, it should be understood that all or part of a primary memory may be provided within or otherwise co-located/coupled with processing unit(s) 302, or other like circuitry within mobile device 104. Secondary memory 304-2 may comprise, for example, the same or similar type of memory as primary memory and/or one or more data storage devices or systems, such as, for example, a disk drive, an optical disc drive, a tape drive, a solid motion state memory drive, etc.

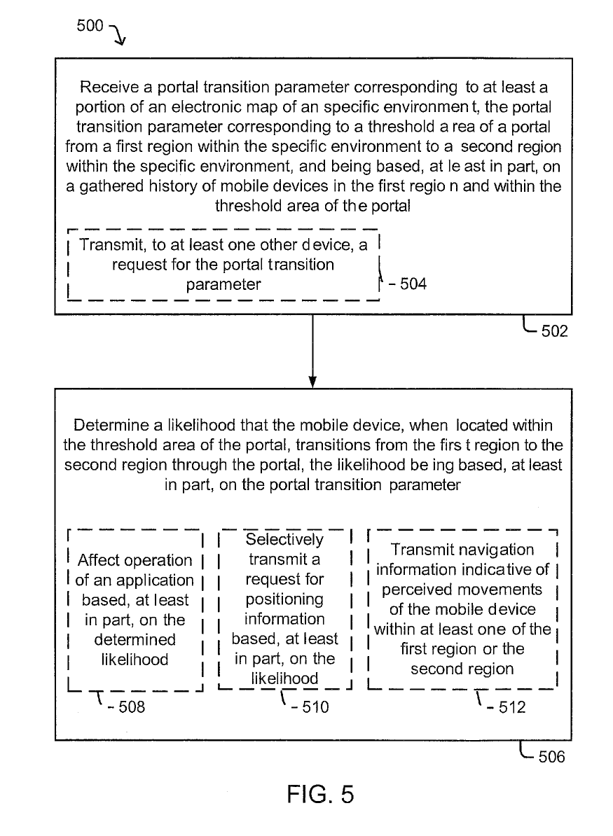

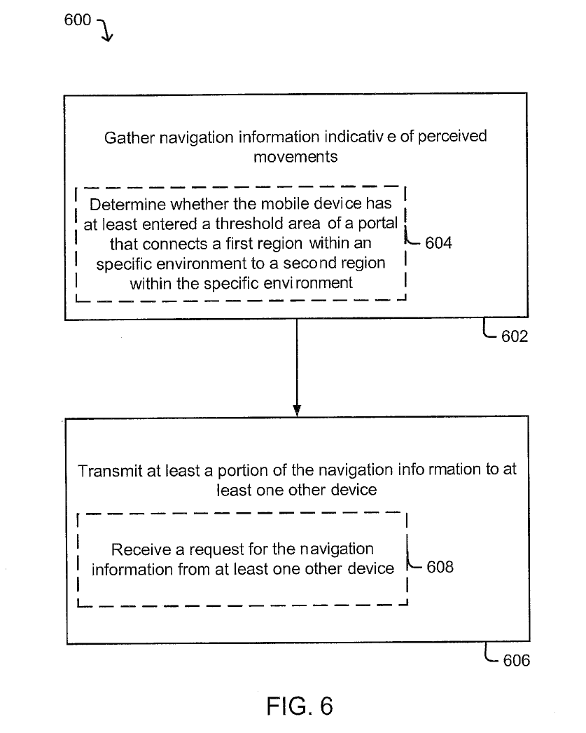

In certain implementations, secondary memory may be operatively receptive of, or otherwise configurable to couple to, a non-transitory computer readable medium 370. Memory 304 and/or non-transitory computer readable medium 370 may comprise instructions 372 for use in performing data processing, e.g., in accordance with the techniques and/or example apparatus 110 (FIG. 1) and/or all or part of example process 500 (FIG. 5) and/or example process 600 (FIG. 6), e.g., as provided herein.

Computing platform 300 may, for example, further comprise one or more communication interface(s) 308. Communication interface(s) 308 may, for example, comprise one or more radios, represented here by one or more receivers 310, and/or one or more transmitters 312. It should be understood that in certain implementations, one or more radios 313 may comprise one or more receivers, one or more transmitters, and/or one or more transceivers, and/or the like. Further, it should be understood that although not shown, one or more radios 313 may comprise one or more antennas and/or other circuitry as may be applicable given the radios function/capability.

By way of further example, communication interface(s) 308 may, for example, provide connectivity to network(s) 120, computing device 102, and/or other resources (devices) 130 (FIG. 1), e.g., via one or more wired and/or wireless communication links. As illustrated here communication interface(s) 308 may comprise one or more receivers 310, one or more transmitters 312, and/or the like or some combination thereof. Communication interface(s) 308 may implement one or more communication protocols as may be required to support one or more wired and/or wireless communication links. Communication interface(s) 308 may, in certain example instances, further comprise one or more receivers capable of receiving wireless signals 142 from one or more transmitting devices 140. Further, in certain example instances, mobile device 104 may comprise an SPS receiver 318 capable of receiving and processing SPS signals 152 in support of one or more signal-based positioning capabilities.

In accordance with certain example implementations, communication interface(s) 208, communication interface(s) 308, transmitting devices 140, and/or other resources in network(s) 120 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 208 and/or communication interface(s) 308 may further provide for infrared-based communications with one or more other devices. A WLAN may, for example, comprise an IEEE 802.11x network or other network, and a WPAN may comprise a Bluetooth network, an IEEE 802.15x network, or other network, for example. Wireless communication implementations described herein may also be used in connection with any combination of WWAN, WLAN or WPAN. In another aspect, a wireless transmitting device may comprise a femtocell, utilized to extend cellular telephone service into a business or home. In such an implementation, one or more mobile devices may communicate with a femtocell via a CDMA cellular communication protocol, for example, and the femtocell may provide the mobile device access to a larger cellular telecommunication network by way of another broadband network such as the Internet.

Mobile device 104 may, for example, further comprise one or more input/output units 314. Input/output units 314 may represent one or more devices or other like mechanisms that may be used to obtain inputs from and/or provide outputs to one or more other devices and/or a user of mobile device 104. Thus, for example, input/output units 314 may comprise various buttons, switches, a touch pad, a trackball, a joystick, a touch screen, a microphone, a camera, and/or the like, which may be used to receive one or more user inputs. In certain instances, input/output units 314 may comprise various devices that may be used in producing a visual output, an audible output, and/or a tactile output for a user. For example, input/output units 314 may be used to present a solicitation to the user and to obtain certain corresponding user inputs. For example, input/output units 314 may be used to obtain one or more user preferences regarding navigation, and in particular, one or more types of portals that may or may not be preferred for use by the user and/or based on the provisioning of mobile device 104. For example, a user preference may indicate that a user prefers elevators over staircases/escalators, etc. In certain implementations one or more user inputs may be obtained via a graphical user interface (GUI) and/or other like capability which allows a user to view all or part of an electronic map and/or related information associated with a specific environment and interact with such visible display via a mouse, a trackball, etc., in some manner. Here, in particular example, a user may view a schematic diagram of a floor plan of a structure in a specific environment via a display (e.g. an input/output unit 314). Here, in this example, such a user may further selectively apply an indication to certain features and/or objects in the displayed schematic diagram to indicate that the feature and/or object is or is not a portal. For example, as illustrated by way of further example herein, a displayed schematic diagram may include one or more elevators which may be marked or otherwise indicated by a user using an input/output unit 314 as representing a portal between two or more regions. Apparatus 110 may, for example, transmit information to apparatus 112 which may be used to affect an electronic map and/or other like data file, and/or establish new or further metadata and/or data files indicative of such identified portals. In certain instances, in addition to producing a visual output, input/output units 314 may comprise various devices that may be used in producing an audible output and/or a tactile output for a user.

Mobile device 104 may, for example, comprise one or more sensors 316. For example, sensor(s) 316 may represent one or more inertial sensors, one or more environmental sensors, etc., which may be useful in detecting aspects of the environment 100 and/or mobile device 104. Thus for example, sensor(s) 316 may comprise one or more accelerometers, one or one or more gyroscopes or gyrometers, one or more magnetometers and/or the like, one or more barometers, one or more thermometers, etc. Further, in certain instances sensor(s) 316 may comprise one or more input devices such as a microphone, a camera, a light sensor, etc. In certain instances, one or more signals generated by one or more sensors 316 may also be considered in estimating a position of mobile device 104, e.g., using various known techniques such as dead reckoning, etc. Accordingly, information from one or more sensors 316 may also be indicative of movement via a portal. For example, an accelerometer may generate information indicative of a vertical acceleration associated with an elevator, escalator, etc. For example, a barometer may generate information indicative of a change in elevation/altitude associated with an elevator/escalator, etc. For example, accelerometer and/or gyroscope may generate information indicative of a particular mode of pedestrian movement, e.g., such as walking or running, climbing the ladder, etc. Conversely, in similar examples, a lack of such generated information may be indicative of a lack of significant motion.

Processing unit(s) 302 and/or instructions 372 may, for example, provide or otherwise make use of one or more signals that may be stored in memory 304 from time to time and which may represent data and/or instructions, such as: instructions 372; apparatus 110; one or more portal transition parameters 222□ (e.g., a probability, a value, a function, a subset of grid points, a set of ranked grid points, grid point rankings, a threshold area measurement, etc.); one or more indicators of likelihood 224□ (e.g., a probability, a value, a function, etc.); a routability graph 242□; one or more location context identifier(s) (LCI(s)) 244□; one or more mobile device features 250□; one or more user preferences 252□ (e.g. associated with the mobile device 104); navigation information 256□ (e.g., associated with mobile device 104); one or more requests 258□ (e.g., for navigation information, received from computing device 102, etc.); one or more reported transitions 262□ (e.g., associated with transitions made by mobile device 104); a mobile device state 320 (e.g., based on one or more acquired wireless signals, one or more user inputs, one or more onboard sensors, and/or the like or some combination thereof); an estimated location 322; one or more applications 324, or other like function/capabilities; an active scanning operation 326 (e.g., associated with one or more applications 324); a request 328 (e.g., for a portal transition parameter); a request 330 (e.g., for positioning information corresponding to one or more regions, LCI's, etc.); and/or the like or some combination thereof. It should be kept in line, that in certain example implementations, some types of data may comprise or otherwise be represented at least in part by one or more functions and/or other like computer implementable instructions, e.g., which may be used to calculate certain data values, etc. Additionally, while some of the example data and/or instructions as illustrated in FIG. 3 share the same names as example data and/or instructions as illustrated in FIG. 2, it should be kept in mind that in certain instances all or part of such example data and/or instructions may be distinctly different. It should be understood that one or more of these data/information elements may be optional and as such omitted in certain implementations.

SPS receiver 318 may be capable of receiving and acquiring SPS signals 152 via one or more antennas (not shown). SPS receiver 318 may also process, in whole or in part, acquired SPS signals 152 for estimating a position or location of mobile device 104. In certain instances, SPS receiver 318 may comprise one or more processing unit(s) (not shown), e.g., one or more general purpose processors, one or more digital signal processors DSP(s), one or more specialized processors that may also be utilized to process acquired SPS signals, in whole or in part, and/or calculate an estimated location of mobile device 104. In certain implementations, all or part of such processing of acquired SPS signals may be performed by other processing capabilities in mobile device 104, e.g., processing unit(s) 302, memory 304, etc., in conjunction with SPS receiver 318. Storage of SPS or other signals for use in performing positioning operations may be performed in memory 304 or registers (not shown).

Sensors 316 may generate analog or digital signals that may be stored in memory 304 and processed by DSP(s) (not shown) or processing unit(s) 302 in support of one or more applications such as, for example, applications directed to positioning or navigation operations, active wireless scanning operations etc.

Processing unit(s) 302 may comprise a dedicated modem processor or the like that may be capable of performing baseband processing of signals received and downconverted at receiver(s) 310 of communication interface(s) 308 or SPS receiver 318. Similarly, a modem processor or the like may perform baseband processing of signals to be upconverted for transmission by wireless transmitter(s) 312. In alternative implementations, instead of having a dedicated modem processor, baseband processing may be performed by a general purpose processor or DSP (e.g., general purpose/application processor). It should be understood, however, that these are merely examples of structures that may perform baseband processing, and that claimed subject matter is not limited in this respect. Further, processing of other frequencies, for example IF or transmission frequencies, may be performed.

Attention is drawn next to FIG. 4, which is a flow diagram illustrating an example process 400 that may be implemented in whole or in part in an electronic device, such as a computing platform 200, e.g., as in FIG. 2, to support certain positioning capabilities in a mobile device, for example based, at least in part, on computing at least one portal transition parameter, in accordance with an example implementation. Items illustrated in FIG. 4 with dashed-lines may be omitted in some embodiments. In process 400, blocks 402, 404, 406, 408, 410, 412, and 416 may, for example, be performed, at least in part, by processing unit 202. In process 400, blocks 414 and 418 may, for example, be performed, at least in part, by communication interface(s) 208.

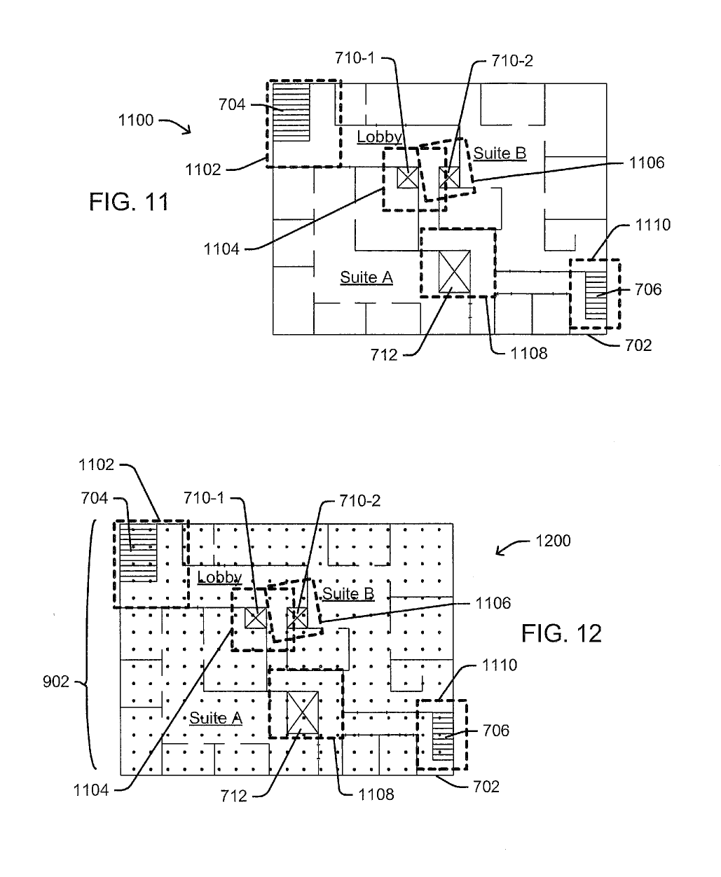

At example block 402, a portal connecting a first region within a specific environment and a second region within the specific environment may be identified. Here, for example, such a portal may be identified based, at least in part, on an electronic map corresponding to at least a portion of the specific environment. In certain implementations, a portal may be identified, at least in part, based on one or more user inputs obtained during a manual or otherwise interactive map extraction/analysis process. For example, FIG. 11 relates to an example interactive map extraction/analysis process. In certain implementations, a portal may be identified, at least in part, based on one or more automated capabilities associated with an extraction/analysis process. For example, FIG. 10 relates to a map extraction/analysis process which may be interactive and/or automated.

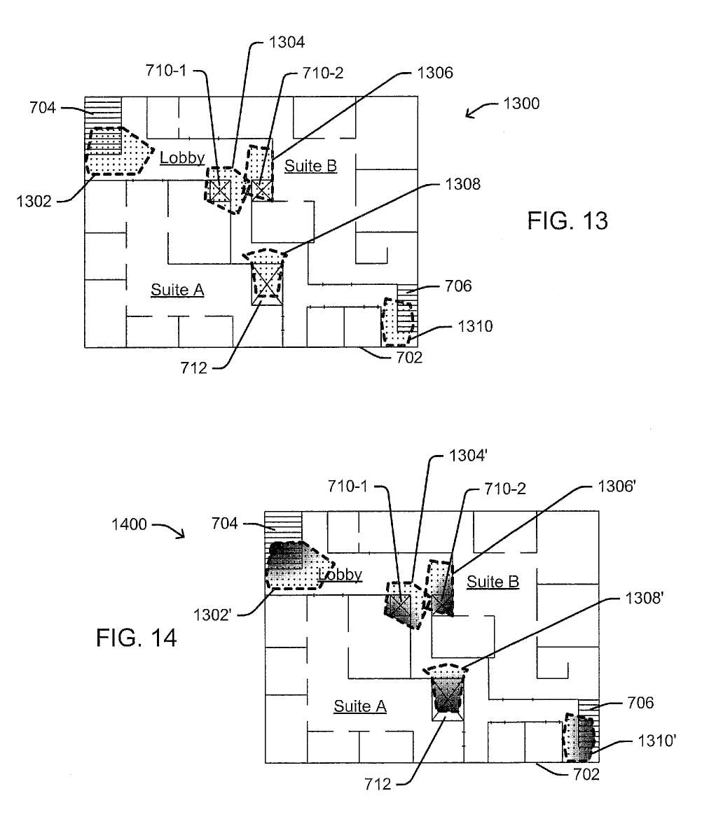

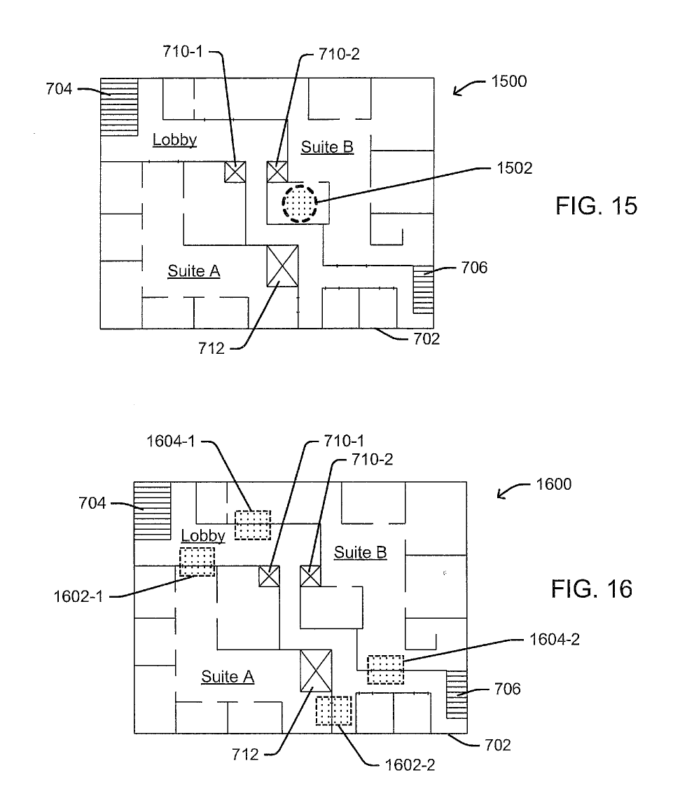

In certain example implementations, at block 404, a threshold area of a portal may be identified. For example, a threshold area of a portal may be identified based, at least in part, on at least one user input parameter corresponding to an electronic map. For example, FIG. 11 illustrates example areas (e.g. see 1102, 1104, 1106, 708, and 1110) based on user input parameters interactively drawn or otherwise created with regard to a displayed version of a schematic of a floor plan. In another example, a threshold area of a portal may be identified based, at least in part, on one or more user input parameters and/or based on a gathered history. For example, FIGS. 13 and 14 illustrate some threshold areas (e.g. see 1302, 1304, 1306, 1308, and 1310) based, at least in part, on a gathered history. In yet another example, a threshold area of an inferred portal may be identified based, at least in part, on received navigation information (e.g., from a plurality of mobile devices). For example, FIG. 15 illustrates an example of an inferred portal all or part of which may be within (e.g., surrounded in-part, or possibly adjacent or otherwise nearby) to threshold area 1502.

In certain instances, at example block 406, a subset of grid points corresponding to an electronic map may be identified as representing a threshold area of a portal. For example, FIG. 12 illustrates some threshold areas represented by subsets of grid points. For example, FIG. 13 illustrates some threshold areas represented by clustered subsets of grid points. In certain instances, two or more grid points in a subset of grid points may be ranked based on some criteria, such as, e.g., increased probability of transitioning via the portal associated with the threshold area. For example, FIG. 14 illustrates, e.g., by way of a visible grayscale diffusion pattern, an example ranking of grid points wherein the darker the grayscale the higher the probability that a mobile device will transition via the portal is located at or near such grid point. Conversely, in this example, lightly shaded a grid point within an example threshold area may have a lower probability that the mobile device will transition via the portal. Such representations are shown herein for visual reference/illustration, and subject matter is not limited by any of the particular examples presented herein.

In certain example implementations, portal probability diffusion may be taken into consideration for identified portals and threshold areas. For example, grid points near and within an identified portal and/or a corresponding threshold area may be identified as portal grid points. Additionally, as mentioned such grid points may be ranked based on their significance or some other like aspect with respect to their applicable portal. In certain instances, grid points that are more likely to invoke a transition and/or correspond to a user using the portal may be ranked higher than others which may simply be nearby the portal. This example type of ranking may be determined by identifying more centralized grid points in a cluster corresponding to the portal, and/or possibly by applying crowdsourcing operations and/or other like methods to identify grid points of a portal and/or corresponding threshold area that may be more significant than others with regard to predicting a user transition or lack thereof via such portal.

In certain instances, one or more geometric features that may be identified in an electronic map and/or the like may be taken into consideration in ranking or otherwise affecting some other aspect applied to nearby grid points, e.g., which may be associated with individual or possibly shared portal counters, etc. Here, for example, with a portal counter or other like measurement mechanism, individual grid points and/or possibly adjacent groups of grid points (e.g., sharing a portal counter) may be differentiated from one another by incrementing/decrementing their corresponding portal counters. Thus, in an example, a portal counter for a grid point located a significant distance from any portal may remain set to zero (0) or some other nominal value, while a grid point located within a threshold area of a portal may have been incremented from the nominal value to a higher value that may be indicative of their location relative to the portal and/or relative to information in a gathered history, etc.

In certain instances, grid points with their portal counters at the nominal value and/or within a particular threshold range may be removed from consideration when analyzing grid points that may be nearer to or otherwise associated with known portals or unknown portals that may be inferred. For example, it may be beneficial to remove certain grid points and/or their surrounding areas prior to or as part of a clustering algorithm that groups and/or combines certain other grid points and/or their surrounding areas that may be indicative of known portals or unknown portals that may be inferred.

As such, in certain example implementations, a clustering algorithm may determine and/or make use of a subset of grid points, some of which may be determined to be isolated in groups or clusters (e.g., of one or more grid points) representing the individual known or possibly inferred portals and/or their corresponding threshold areas.

In certain instances, at example block 408, a portal may be identified by inference based, at least in part, on received navigation information (e.g., from a plurality of mobile devices). For example, FIG. 15 illustrates an example of an inferred portal within threshold area 1502.

As mentioned, in certain instances, a threshold area of a portal may be based, at least in part, on an identifier associated with at least one feature encoded within the electronic map. For example, FIG. 10 illustrates how certain features which are indicative of a portal may be encoded as part of a layer which may be extracted from an electronic map. In such embodiments, all features on a particular layer, for example a layer showing elevators, may be identified as portals. In some embodiments, certain shapes and/or symbols may be known to represent portals and may be identified in the electronic map. In certain other implementations, one or more features encoded with an electronic map may have a particular identifier which may be indicative that the feature is or relates to a portal. For example, an electronic map may comprise one or more computer-aided design (CAD) drawings which may have various drawing layers, various drawing types, and/or otherwise make use of certain searchable codes, and/or the like to uniquely identify certain features and/or objects. For example, certain features may be uniquely identified as elevators, escalators, staircases, ladders, doorways, entries, exits, windows, tunnels, conduits, etc. In some embodiments, text or labels identifying certain features may be used to identify one or more portals.

At example block 410, a portal transition parameter may be computed based, at least in part, on a likelihood that a mobile device, if located in the first region and within a threshold area of the portal, may or may not transition from the first region to the second region through the portal. Here, for example, an indicator of such a likelihood may be based, at least in part, on a gathered history of mobile devices in the first region and within the threshold area of the portal.

In certain instances, at block 412, an indicator of such a likelihood may be calculated. For example, in certain implementations an indicator of such a likelihood may be calculated based, at least in part, on a probability that a user transporting the mobile device and located within the threshold area of the portal may or may not remain within the first region. For example, in certain implementations an indicator of such a likelihood may be calculated based, at least in part, on a probability that user transporting the mobile device and located within the threshold area of the portal may or may not transition from the first region to the second region using the portal. In still other examples, in certain implementations, an indicator of such a likelihood may be calculated based, at least in part, on a point of interest (POI) identified in the electronic map within the first region or the second region, or possibly in another region connected to the second region but not the first region. In still other example implementations, an indicator of such a likelihood may be calculated based, at least in part, on a type of the portal (e.g., a portal type), an operational feature of the portal (e.g., a portal operational feature), an identifiable feature of the mobile device, a user preference, a perceived level of use of the portal (e.g., based on gathered history, etc.), and/or the like or some combination thereof.

In certain instances, at block 414, navigation information may be received which is indicative of perceived movements of at least one mobile device within at least one of the first region or the second region of a specific environment. For example, in certain instances, navigation information may be requested (e.g., solicited) from one or more mobile devices as part of a crowd sourcing operation and/or the like. For example, in certain instances navigation information may be received, with or without previous solicitation, from one or more mobile devices. In certain implementations, navigation information may comprise a reported transition, e.g. from one region/LCI to another via a previously identified portal, or possibly by a previously unidentified portal, the latter of which may become an inferred portal/threshold area at some point in time. Thus, for example, at example block 416, in certain instances, all or part of a gathered history may be affected based, at least in part, on a reported transition from the first region to the second region of at least one mobile device without using at least one previously identified portal connecting the first region to the second region.

At example block 418, a portal transition parameter may be transmitted to at least one mobile device. Here, in certain examples, a portal transition parameter may be provided in addition to an electronic map, routability graph, and/or the like. For example, portal transition parameter may be provided as metadata and/or the like. In certain other examples, a portal transition parameter may be provided as part of an electronic map, routability graph, and/or the like or some portion thereof. In still other implementations a portal transition parameter may be provided as part of a message and/or response (e.g. to a request). In certain implementations, a portal transition parameter may be provided with a plurality of portal transition parameters, and/or other like information.

Attention is drawn next to FIG. 5, which is a flow diagram illustrating an example process 500 that may be implemented in whole or in part in an electronic device, such as a mobile device 104, e.g., as in FIG. 3 to support certain positioning capabilities, for example based, at least in part, on at least one portal transition parameter, in accordance with an example implementation. Items illustrated in FIG. 5 with dashed-lines may be omitted in some embodiments. In process 500, blocks 502 and 506 may, for example, be performed, at least in part, by processing unit 302. In process 500, blocks 504, 510 and 512 may, for example, be performed, at least in part, by communication interface(s) 308.

At example block 502, a portal transition parameter may be received. Here, for example, a portal transition parameter may correspond to at least a portion of an electronic map of a specific environment, such as, e.g., a threshold area of a portal from a first region within the specific environment to a second region within the specific environment. In certain instances, at example block 504, a request for a portal transition parameter may be transmitted by the mobile device to at least one other device. As previously described, a portal transition parameter may be based, at least in part, on a gathered history of mobile devices in the first region and particularly within the threshold area of the portal.

At block 506, an indicator of a likelihood may be determined based, at least in part, on a portal transition parameter, e.g., as received at block 502. Here, for example, such an indicator of a likelihood may correspond to a likelihood that the mobile device, if located within a threshold area of the portal, may or may not transition from the first region to the second region through the portal.

In certain instances, a current state of the mobile device including at least a location of the mobile device in the first region may be determined. Here, for example, a first region may be identifiable by a first LCI and the second region being identifiable by second LCI which is different than the first LCI. In certain instances, such a current state may then be associated with the portal. In certain instances, for example at block 508, an operation of an application may be affected based, at least in part, on the determined likelihood from block 506. For example, in certain implementations, operation of an application for selecting an LCI from among a plurality of LCIs may be affected in some manner e.g., in response to, at least in part, the determined likelihood.

At example block 510, a request for positioning information may be selectively transmitted to one or more other devices based, at least in part, on the determined likelihood. For example, in certain implementations, a request for positioning information (e.g., electronic map information, radio heatmaps, routability graphs, location-based services information, etc.) corresponding to at least one LCI may be selectively transmitted based, at least in part, on a determined likelihood. By way of an example, it may be useful to initiate a request and obtain positioning information (possibly in advance) for one or more LCIs, etc., should a determined likelihood that a mobile device may transition to such LCI(s), etc exceed a threshold, for example. Hence, if a determined likelihood may range from a low value of 0.00 to a high value of 0.99, in certain instances it may be beneficial to request positioning information for a particular region in response to a determined likelihood that a mobile device may transition to the particular region exceeding some threshold value (e.g., 0.75).

Similarly, as previously mentioned, in certain implementations operations involving active scanning and/or other processes may be affected in some manner based on a determined likelihood that a mobile device may transition to such LCI(s), etc. Again, assuming by way of example that a determined likelihood may range from a low value of 0.00 to a high value of 0.99, in certain instances it may be beneficial to affect the operation of one or more processes based on the likelihood that a mobile device may transition to the particular region exceeding some threshold value (e.g., 0.65). For example, it may be beneficial to initiate, pause, stop, restart, or otherwise affect operation of one or more processes that may be useful should the mobile device actually transition to another region. Here, for example, in light of a potential transition it may be useful to pause an on-going active scan for wireless services, etc., or conversely to initiate, restart, schedule, etc., an active scan for the possibly next region. At example block 512, navigation information indicative of perceived movements of the mobile device within at least one of the first region or the second region may be transmitted to one or more other devices. In certain instances, such navigation information may be transmitted in response to a request for navigation information from at least one other device. For example, a computing device may request certain navigation information as part of a crowd sourcing operation to assist in identifying portals and/or threshold areas relating thereto for a given specific environment.

Attention is drawn next to FIG. 6, which is a flow diagram illustrating an example process 600 that may be implemented in whole or in part in an electronic device, such as a mobile device 104, e.g., as in FIG. 3 to support certain positioning capabilities, for example based, at least in part, on gathering navigation information indicative of perceived movements of the mobile device and which may subsequently be used, at least in part, in a computing at least one portal transition parameter, in accordance with an example implementation. Items illustrated in FIG. 6 with dashed-lines may be omitted in some embodiments. In process 600, blocks 602 and 604 may, for example, be performed, at least in part, by processing unit 302. In process 600, blocks 606 and 608 may, for example, be performed, at least in part, by communication interface(s) 308.

At example block 602, navigation information indicative of perceived movements of the mobile device, e.g. with regard to a portal and/or threshold area associated with such portal may be gathered. For example, navigation information may be based, at least in part, on one or more acquired wireless signals, and/or one or more signals generated by one or more onboard sensors. In certain implementations, at example block 604, a mobile device may determine whether it has at least entered a threshold area of the portal that connects a first region with a second region. Here, for example, navigation information may be indicative of such a determination. Additional navigation information may be gathered which indicates whether or not such a mobile device having entered a threshold area of a portal makes use of the portal to transition to the second region or remains in the first region. In another example, a navigation information may be indicative of a transition from a first region to a second region occurring at some point in time, e.g., possibly through a previously identified portal or possibly through a previously unidentified portal which may at some point become an identified portal through inference based on a gathered history.

At example block 606, at least a portion of the navigation information may be transmitted to at least one other device. In certain instances, a mobile device may independently decide to transmit at least a portion of the navigation information to at least one other device. In certain instances, at example block 608, a request for navigation information may be received from one or more other devices. Hence, in certain instances a mobile device may transmit at least a portion of the navigation information in response to such a request(s). As previously mentioned such navigation information may be combined with navigation information from one or more other mobile devices or otherwise used to affect a gathered history which may be used in computing a portal transition parameter with regard to the particular specific environment.

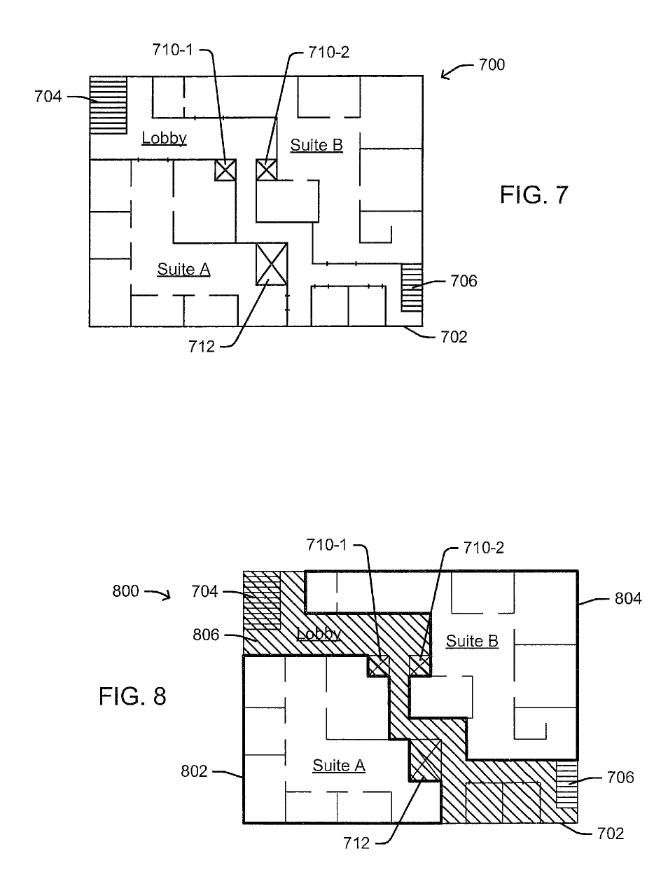

Reference will now be made to several schematic diagrams of an exemplary portion of a building as initially presented in FIG. 7 as diagram 700. Diagram 700 presents an example floor plan of portion 702 of a structure. Portion 702 may, for example, represent one level of a multi-level building, wherein one or more adjacent and/or other levels may be transitioned to via a primary staircase 704, a secondary staircase 706, a first passenger elevator 710-1, a second passenger elevator 710-2, or a service elevator 712. Thus, for example, if portion 702 represents a first region, and all or part of one or more other levels represents a second portion, then primary staircase 704, secondary staircase 706, first passenger elevator 710-1, second passenger elevator 710-2, and service elevator 712 may represent portals connecting such a first region with such a second region.

By way of another example, portion 702 comprises two office suites, namely “Suite A” and “Suite B” and which are interconnected by a shared area comprising a “Lobby” which extends as a set of interconnected hallways between the two office suites leading from primary staircase 704 to secondary staircase 706, and providing access to the various elevators. Thus, as illustrated by the highlights and shading in diagram 800 of FIG. 8, in certain instances, Suite A may represent a first region 802 and Suite B may represent a second region 804, which are separated by and operatively shared space 806, all or part of which may be considered to represent at least one portal between first region 802 and second region 804. Indeed, diagram 1600 in FIG. 16 further illustrates that threshold areas 1602-1 and 1602-2 may be identified at or about all or part of the entry/exit ways for Suite A, and threshold areas 1604-1 and 1604-2 may be identified at or about all or part of the entry/exit ways for Suite B.

Thus it should be kept in mind that, as previously mentioned, first and second regions may be located on the same level, occupy different levels, occupy partial levels, occupy all or part of different structures, etc.

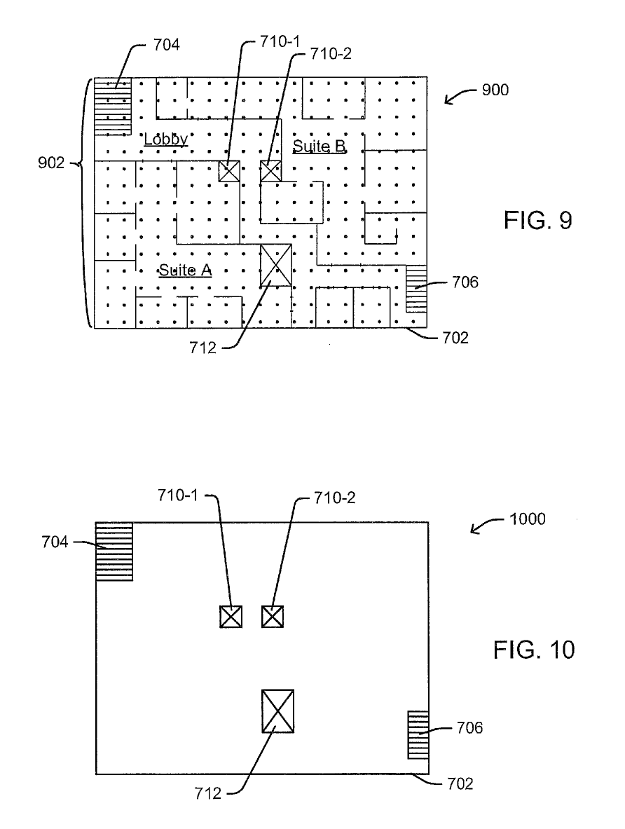

Attention is drawn next to FIG. 9, which is a schematic diagram 900 illustrating an example wherein a plurality of grid points 902 may be associated with all or part of a corresponding electronic map and/or the like, in accordance with an example implementation. As with all of the drawings presented herein, claimed subject matter is not intended to necessarily be limited by the illustrated drawings, nor are the illustrated drawings intended to represent any proper scale with regard to an actual physical implementation. Hence, grid points 902 are intended simply to illustrate that a plurality of grid points, which may be part of or associated with an electronic map, a routability graph, a radio heatmap, and/or the like may be provisioned as illustrated in subsequent sections and may possibly be used in defining a portal, a threshold area of a portal, and/or possibly a portal transition parameter relating thereto.

As mentioned previously with regard to block 402 of process 400 in FIG. 4, in certain instances one or more portals may be identified within all or part of an electronic map using manual/interactive and/or possibly more automated map extraction/analysis techniques. By way of one example, attention is drawn to FIG. 10, which is a schematic diagram 1000 illustrating an example wherein certain features of the floor plan may be indicated and/or otherwise made identifiable as portals within a particular data set and/or data file provided in a corresponding electronic map and/or the like, in accordance with an example implementation. Here, for example, a CAD diagram and/or other like drawing-based data file may comprise a plurality of separable layers and/or other like data that may be parsed or otherwise searched in some manner to indicate certain features/objects that may be indicative of a portal. In this example, diagram 1000 represents a layer which comprises the staircases and elevators which may extend up/down from portion 702 to one or more other levels. In certain instances, while not illustrated in diagram 1000, such a layer may further comprise certain plumbing, structural, and/or other like features and/or objects which may extend between levels. In certain instances, a layer and/or other like information such as diagram 1000 may be considered during a map extraction and/or map analysis process.

Attention is drawn to FIG. 11, which is a schematic diagram 1100 illustrating that certain features of the floor plan may be indicated and/or otherwise made identifiable as portals, e.g., based, at least in part, on one or more user inputs and/or as a result of an automated map extraction and/or map analysis process, as portals. As illustrated, a mark 1102 surrounds primary staircase 704 and part of the adjacent lobby to indicate that a portal, i.e., primary staircase 704, has been identified. Similarly, a mark 1104 surrounds first passenger elevator 710-1 and portions of some surrounding areas to indicate that a portal, i.e., first passenger elevator 710-1, has been identified. Further, a mark 1106 surrounds second passenger elevator 710-2 and portions of some surrounding areas to indicate that a portal, i.e., second passenger elevator 710-2, has been identified. Also, a mark 1108 surrounds service elevator 712 and portions of some surrounding areas to indicate that a portal, i.e., service elevator 712, has been identified. A mark 1110 surrounds secondary staircase 706 and portions of some surrounding areas to indicate that a portal, i.e., secondary staircase 706, has been identified. By way of example, with a manual/interactive map extraction/analysis process, a user may provide appropriate user input to indicate the marked portals as identified in the example of diagram 1100. By way of example, an automated map extraction/analysis process, application and/or other like function may provide appropriate marking for the identified portals. Again, as previously mentioned and illustrated in FIG. 10, in certain instances an electronic map and/or other like data file may be processed in a manner which may support manual/interactive and/or more automated map extraction/analysis processes.

By way of an additional example, portal identification may make use of GUI and/or CAD capabilities to show/hide/separate various parsed data and/or individual layers, which may then be marked as a portal. In another implementation, automated functions and/or other interactive tools may also be applied which identify certain geometric features and/or other like data which may be associated with certain types of portals. Further, in certain instances portals may be identified based on particular codes and/or other like indicators within an electronic map and/or the like.

Attention is drawn next to FIG. 12, which is a schematic diagram 1200 illustrating an example wherein a plurality of grid points 902 may be associated with all or part of a corresponding electronic map and/or the like, and applied marks 1102, 1104, 1106, 1108, and 1110. Hence, as illustrated, each mark identifying a portal may comprise a subset of grid points. In certain instances, a particular mark may serve as threshold area. However, as may be appreciated, in certain instances a particular mark indicating an identified portal may be too large or too small and/or may overlap with other nearby marks.

Hence, in certain instances it may be beneficial to further process marked regions, and in particular grid points therein in some manner which may lead to a threshold area that may be more tightly focused on a particular portal. To accomplish this, for example, a portal probability diffusion process may be implemented which makes use of identified portals and nearby/applicable grid points. As previously mentioned, and illustrated in subsequent sections, in certain instances nearby/applicable grid points may be ranked with regard to a particular portal, e.g., based at least in part on their significance to the portal feature. For example, grid points closer to a step in a staircase may be ranked as having a higher significance when compared to grid points further away from the staircase itself, e.g. out in the hallway or lobby, since a mobile device located at or near a step of the staircase may be more likely involved in a transition via the staircase than might be a mobile device located at or near a grid two meters away from the staircase. In another example, and for the similar reasons, grid points within the lobby in front of and nearby a door of an elevator may be ranked as having a higher significance than grid points located two meters away from the elevator. However, by taking into account a gathered history of mobile devices, in certain instances, grid points that are more likely to invoke a transition or correspond to the user using a portal may be ranked higher than grid points that are simply close to the portal or correspond to the portal. Hence, crowd sourcing techniques may be implemented to improve efficiency of a threshold area in predicting whether a mobile device may be transitioning from one region to another via a particular portal. In certain other implementations, a clustering algorithm and/or other like techniques may also be implemented to further focus a threshold area on more centralized grid points corresponding to the use of a portal for transitioning. In certain other implementations, geometric features and/or other objects that may be identified in an electronic map, routability graph, and/or the like may be taken into consideration to focus a threshold area on grid points more likely to correspond to an expected location of the mobile device that may be using the portal to transition from one region to another. In certain example implementations, grid points that are associated with various features or obstacles, known or unknown, which appear to preclude or otherwise prevent mobile devices from being so located, may be removed from subsets of grid points representing threshold areas. In certain example implementations grid points may be associated with portal counters which increment or decrement according to reported transitions and/or other navigation information.

While the example threshold areas and portals are presented herein in a static format, it should be kept in mind that in certain implementations one or more threshold areas and/or portals may relate to a more dynamic format. For example, certain portals may or may not be available for transitioning depending upon a time of day or day of week. Here, for example, a service elevator may be unavailable for transitioning during office hours. In another example, certain portals may only be available for certain types of transitioning, e.g., available for emergency egress, available for service personnel, available for security personnel, available for a particular group of users, etc. In yet another example, a particular portal such as an elevator may at times be limited to serving particular floors or levels. In still another example, a particular portal such as an escalator may operate in a manner which provides for transitions in one direction only, and which in certain instances may be dynamically changed, e.g. to deal with the direction best served at a particular point in time.

As previously mentioned a subset of grid points may be identified as being associated with a mark identifying a portal, and such a subset of grid points may be further considered as part of one or more processes, e.g., to provide a desired level of probability with regard to a particular portal. In certain implementations, a clustering algorithm and/or the like may be used to group grid points together for a particular portal, and as such the resulting threshold area may itself represent the particular portal.

This in mind, attention is drawn next to FIG. 13, which is a schematic diagram 1300 illustrating an example wherein the identified portals are further associated with applicable, example, threshold areas, which may also comprise or otherwise be associated with specific subsets of grid points that may be associated with all or part of a corresponding electronic map and/or the like. Here, for example, primary staircase 704 having been identified as a portal has been associated with a threshold area 1302, first passenger elevator 710-1 having been identified as a portal may be associated with a threshold area 1304, second passenger elevator 710-2 having been identified as a portal may be associated with a threshold area 1306, service elevator 712 having been identified as a portal may be associated with a threshold area 1308, and secondary staircase 706 having been identified as a portal may be associated with a threshold area 1310.

Schematic diagram 1400 of FIG. 14 further illustrates, via defused shading, an example wherein a subset of grid points within a threshold area of a particular identified portal may be ranked, in accordance with an example implementation. Here, clusters of grid points are illustrated as being ranked with respect to one another in example threshold area 1302□, example threshold area 1304□, example threshold area 1306□, example threshold area 1308□, and example threshold area 1310□. It should be noted that the shading techniques and shapes applied illustrate the threshold areas in this example are not intended to be properly scaled and/or represent that of an actual portal and/or threshold area. Indeed, in certain instances a area may or may not extend into the actual portal feature or implementation. Thus, for example, in certain implementations a threshold area may reside outside of an elevator car/shaft, or not overlap part of a staircase or escalator, just to name a few examples. In certain implementations, a threshold area may be represented by a subset of grid points comprising one or more grid points. Although the illustrated examples represent the use of grid points, e.g., a set of unique coordinates, etc., it should be kept in mind that in other implementations, a grid point may be replaced by some other representative shape and/or identifiable unit. Thus, for example, a subset of grid points may represent a subset of tiles of some shape, etc., or simply portions of some defined array or pattern, etc.

As previously mentioned, a probability of a portal being used to transition between a first region and a second region may further depend on various factors relating to the particular regions, such as, the presence or absence of certain points of interests, etc. Again, while such probability may be static in nature for certain portals, for some portals a probability may be more dynamic depending upon various other factors, such as, e.g., time, date, user, mobile device, etc., and/or some combination thereof. For example, a probability associated with a particular portal leading to a restaurant in a building may change depending upon the date and/or time of day. Indeed, as mentioned, a threshold area may dynamically increase and/or decrease for the same or similar reasons, e.g., based on crowds, traffic pattern, etc.

Hence, the number of factors may be considered in determining a portal transition parameter and as mentioned gathered history may be used to make appropriate adjustments and/or arrange for dynamic changes in a portal transition for a given portal. Furthermore, over time, certain portals and threshold areas may be no longer identified, e.g., if never used or if used less than some threshold number of times for transitioning. Conversely, as previously mentioned, new portals/threshold areas may be inferred and associated portal transition parameters computed, e.g., based on the gathered history, navigation information, reported transitions (or lack thereof), crowd-source operation, and the like.

With this in mind, attention is drawn next to FIG. 15, which is a schematic diagram 1500 illustrating an example inferred portal using threshold area 1502 and which may be associated with subset of grid points. Here, for example, apparatus 112 in a computing device 102 (see FIG. 1) may recognize via gathered history, navigation information, reported transition, etc., that a portal exists within Suite B since transitions have occurred between the region/LCI comprising at least Suite B and some other region(s)/LCI(s). Hence, similar diffusion and/or clustering techniques, and or the like may be implemented in defining threshold area 1502 and other like techniques used to compute a portal transition parameter associated there with. Accordingly, certain techniques presented herein allow for continued refinement and/or updating/maintaining of portal transition parameters and other like information. Furthermore, as previously mentioned, in certain instances one or more crowd-source operations may be undertaken to further explore and/or study particular structures, regions, LCI as, suspected portals, etc. Moreover, in certain implementations, certain crowd source operations may include interactive user capabilities which may provide additional information for consideration in computing portal transition parameter. For example, one or more user preferences may be solicited/received which may affect a portal transition parameter and/or some other factor presented by the techniques herein. In certain other implementations, it may be possible to further include information obtained from one or more other devices within a gathered history associated with a particular portal. For example, in certain implementations, it may be beneficial for a gathered history to take advantage of available traffic information and/or the like which may be recorded and/or otherwise indicated in some manner by other devices such as, e.g., surveillance cameras, microphones, etc., which may be indicative of certain conditions associated with a portal and/or threshold area.

Attention is drawn to FIG. 16, which is a schematic diagram 1600 illustrating example portals and/or threshold areas associated with certain doorways connecting the first and second regions with the operatively shared area, and which may identify particular subsets of grid points that may be associated with all or part of a corresponding electronic map and/or the like, in accordance with an example implementation. In this example, Suite A may represent a first region and Suite B may represent a second region, which are separated by and operatively shared space, all or part of which may be considered to represent at least one portal between first region and second region. Accordingly, threshold areas 1602-1 and 1602-2 may be identified at or about all or part of the entry/exit ways for Suite A, and threshold areas 1604-1 and 1604-2 may be identified at or about all or part of the entry/exit ways for Suite B. As previously mentioned, in certain implementations certain features, and/or regions or areas within a specific environment or portion thereof may be identified based on grid points and/or the like, which may correspond to particular coordinates and/or portions of an electronic map and/or the like.

It should be understood that the term “area” as used herein, for example, with regard to a specific environment, a region, a threshold area and/or an area surrounding a grid point, an electronic map and/or the like, etc., may in certain implementations represent an identifiable portion of a two-dimensional area, or may in certain implementations represent an identifiable portion of a three-dimensional space. Thus, for example, in certain instances a threshold area may represent a two-dimensional area of some shape which relates to an electronic map of a specific environment, e.g., a one meter by two meter area located adjacent to an entry/exit of a floor plan, or all or part of a circular area having a particular radius, etc. However, in certain instances, such a threshold area may also represent a three-dimensional space, e.g., corresponding to a three-dimensional electronic map and/or the actual physical environment. Here, for example, a threshold area may comprise a one meter by two meter by three meter volume of space located adjacent to an entry/exit of a floor plan, or all or part of a spherical volume having a particular radius, etc.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically motion stated otherwise, as apparent from the following discussion, it is appreciated that throughout this specification discussions utilizing terms such as “processing,” “computing,” “calculating,” “determining”, “establishing”, “obtaining”, “identifying”, “applying,” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, with a computing platform:
identifying a portal connecting a first region within a specific environment and a second region within said specific environment, said portal being identified based, at least in part, on an electronic map corresponding to at least a portion of said specific environment; and
computing a portal transition parameter based, at least in part, on a likelihood that a mobile device, if located in said first region and within a threshold area of said portal, transitions from said first region to said second region through said portal, said likelihood being based, at least in part, on a gathered history of mobile devices in said first region and within said threshold area of said portal.

2. The method as recited in claim 1, and further comprising with said computing platform:
transmitting said portal transition parameter to at least one mobile device.

3. The method as recited in claim 1, wherein identifying said portal further comprises:
identifying said threshold area of said portal based, at least in part, at least one user input parameter corresponding to said electronic map.

4. The method as recited in claim 1, wherein identifying said portal further comprises:
identifying said threshold area of said portal based, at least in part, on an identifier associated with at least one feature encoded within said electronic map.

5. The method as recited in claim 1, wherein identifying said portal further comprises:
inferring said threshold area of said portal based, at least in part, on said gathered history.

6. The method as recited in claim 1, wherein identifying said portal further comprises:
identifying a subset of grid points within a plurality of grid points corresponding to said electronic map as representing said threshold area of said portal.

7. The method as recited in claim 6, wherein identifying said subset of grid points further comprises:
ranking at least two grid points in said plurality of grid points based, at least in part, on a perceived significance of at least one feature encoded within said electronic map as representing an available portal within said specific environment; and
identifying said subset of grid points based, at least in part, on said ranking.

8. The method as recited in claim 6, wherein identifying said subset of grid points further comprises:
clustering said subset of grid points to identify said threshold area of said portal.

9. The method as recited in claim 6, wherein said plurality of grid points are provided as part of a routability graph corresponding to at least a portion of said electronic map.

10. The method as recited in claim 1, wherein said first region is identifiable by a first location context identifier (LCI) and said second region is identifiable by a second LCI which is different than said first LCI, and wherein computing said portal transition parameter further comprises, at least one of:
calculating said likelihood based, at least in part, on a probability that a user transporting said mobile device and located within said threshold area of said portal may or may not remain within said first LCI; or.
calculating said likelihood based, at least in part, on a probability that a user transporting said mobile device and located within said threshold area of said portal, may or may not transition from said first LCI to said second LCI using said portal.

11. The method as recited in claim 1, and wherein computing said portal transition parameter further comprises:
calculating said likelihood based, at least in part, on a point of interest identified in said electronic map within said first region or said second region.

12. The method as recited in claim 1, and wherein computing said portal transition parameter further comprises:
calculating said likelihood based, at least in part, on at least one of: a type of said portal, an operational feature of said portal, an identifiable feature of said mobile device, a user preference, at least a portion of said gathered history, or a perceived level of use of said portal.

13. The method as recited in claim 1, and further comprising with said computing platform, at least one of:
as part of a crowd-source operation, transmitting a request for navigation information to at least one mobile device; and/or
affecting said gathered history based, at least in part, on navigation information indicative of perceived movements of at least one mobile device within at least one of said first region or said second region.

14. The method as recited in claim 1, and further comprising with said computing platform:
affecting said gathered history based, at least in part, on a reported transition, from said first region to said second region, of at least one mobile device without using at least one previously identified portal connecting said first region to said second region.

15. An apparatus comprising:
means for identifying a portal connecting a first region within a specific environment and a second region within said specific environment, said portal being identified based, at least in part, on an electronic map corresponding to at least a portion of said specific environment; and
means for computing a portal transition parameter based, at least in part, on a likelihood that a mobile device, if located in said first region and within a threshold area of said portal, transitions from said first region to said second region through said portal, said likelihood being based, at least in part, on a gathered history of mobile devices in said first region and within said threshold area of said portal.

16. The apparatus as recited in claim 15, and further comprising:
means for transmitting said portal transition parameter to at least one mobile device.

17. The apparatus as recited in claim 15, and further comprising:
means for identifying said threshold area of said portal based, at least in part, on at least one of: at least one user input parameter corresponding to said electronic map; an identifier associated with at least one feature encoded within said electronic map; or on said gathered history.

18. The apparatus as recited in claim 15, and further comprising:
means for identifying a subset of grid points within a plurality of grid points corresponding to said electronic map as representing said threshold area of said portal.

19. The apparatus as recited in claim 18, and further comprising:
means for ranking at least two grid points in said plurality of grid points based, at least in part, on a perceived significance of at least one feature encoded within said electronic map as representing an available portal within said specific environment; and
means for identifying said subset of grid points based, at least in part, on said ranking.

20. The apparatus as recited in claim 18, and further comprising:
means for clustering said subset of grid points to identify said threshold area of said portal.

21. The apparatus as recited in claim 15, wherein said first region is identifiable by a first location context identifier (LCI) and said second region is identifiable by a second LCI which is different than said first LCI, and further comprising at least one of:
means for calculating said likelihood based, at least in part, on a probability that a user transporting said mobile device and located within said threshold area of said portal may or may not remain within said first LCI; or
means for calculating said likelihood based, at least in part, on a probability that said user transporting said mobile device and located within said threshold area of said portal, may or may not transition from said first LCI to said second LCI using said portal.

22. The apparatus as recited in claim 15, and further comprising at least one of:
means for calculating said likelihood based, at least in part, on a point of interest identified in said electronic map within said first region or said second region;
means for calculating said likelihood based, at least in part, on a type of said portal;
means for calculating said likelihood based, at least in part, on an operational feature of said portal;
means for calculating said likelihood based, at least in part, on an identifiable feature of said mobile device;
means for calculating said likelihood based, at least in part, on a user preference;
means for calculating said likelihood based, at least in part, on at least a portion of said gathered history; or
means for calculating said likelihood based, at least in part, on a perceived level of use of said portal.

23. The apparatus as recited in claim 15, and further comprising:
means for affecting said gathered history based, at least in part, on navigation information indicative of perceived movements of at least one mobile device within at least one of said first region or said second region.

24. The apparatus as recited in claim 15, and further comprising:
means for affecting said gathered history based, at least in part, on a reported transition, from said first region to said second region, of at least one mobile device without using at least one previously identified portal connecting said first region to said second region.

25. An apparatus comprising:
memory; and
a processing unit in communication with the memory and configured to:
identify a portal connecting a first region within a specific environment and a second region within said specific environment, said portal being identified based, at least in part, on an electronic map corresponding to at least a portion of said specific environment; and
compute a portal transition parameter based, at least in part, on a likelihood that a mobile device, if located in said first region and within a threshold area of said portal, transitions from said first region to said second region through said portal, said likelihood being based, at least in part, on a gathered history of mobile devices in said first region and within said threshold area of said portal.

26. The apparatus as recited in claim 25, and further comprising:
a communications interface; and
said processing unit further configured to initiate transmission of said portal transition parameter to at least one mobile device via said communications interface.

27. The apparatus as recited in claim 25, said processing unit further configured to:
identify said threshold area of said portal based, at least in part, on at least one of: at least one user input parameter corresponding to said electronic map; an identifier associated with at least one feature encoded within said electronic map; or on said gathered history.

28. The apparatus as recited in claim 25, said processing unit further configured to:
identify a subset of grid points within a plurality of grid points corresponding to said electronic map as representing said threshold area of said portal.

29. The apparatus as recited in claim 28, said processing unit further configured to:
rank at least two grid points in said plurality of grid points based, at least in part, on a perceived significance of at least one feature encoded within said electronic map as representing an available portal within said specific environment; and
identify said subset of grid points based, at least in part, on said ranking.

30. The apparatus as recited in claim 28, said processing unit further configured to:
cluster said subset of grid points to identify said threshold area of said portal.

31. The apparatus as recited in claim 25, wherein said first region is identifiable by a first location context identifier (LCI) and said second region is identifiable by a second LCI which is different than said first LCI, and said processing unit further configured to calculate said likelihood based, at least in part, on at least one of:
a probability that a user transporting said mobile device and located within said threshold area of said portal may or may not remain within said first LCI; and/or
a probability that said user transporting said mobile device and located within said threshold area of said portal, may or may not transition from said first LCI to said second LCI using said portal.

32. The apparatus as recited in claim 25, said processing unit further configured to: calculate said likelihood based, at least in part, on at least one of: a point of interest identified in said electronic map within said first region or said second region; a type of said portal; an operational feature of said portal; an identifiable feature of said mobile device; a user preference; a portion of said gathered history; or a perceived level of use of said portal.

33. The apparatus as recited in claim 25, said processing unit further configured to:
affect said gathered history based, at least in part, on navigation information indicative of perceived movements of at least one mobile device within at least one of said first region or said second region.

34. The apparatus as recited in claim 25, said processing unit further configured to:
affect said gathered history based, at least in part, on a reported transition, from said first region to said second region, of at least one mobile device without using at least one previously identified portal connecting said first region to said second region.

35. A non-transitory computer readable medium having computer implementable instructions stored therein which are executable by a processing unit of a computing platform to:
identify a portal connecting a first region within a specific environment and a second region within said specific environment, said portal being identified based, at least in part, on an electronic map corresponding to at least a portion of said specific environment; and
compute a portal transition parameter based, at least in part, on a likelihood that a mobile device, if located in said first region and within a threshold area of said portal, transitions from said first region to said second region through said portal, said likelihood being based, at least in part, on a gathered history of mobile devices in said first region and within said threshold area of said portal.

36. A method comprising, with a mobile device:
receiving a portal transition parameter corresponding to at least a portion of an electronic map of a specific environment, said portal transition parameter corresponding to a threshold area of a portal from a first region within said specific environment to a second region within said specific environment, and being based, at least in part, on a gathered history of mobile devices in said first region and within said threshold area of said portal; and
determining a likelihood that said mobile device, when located within said threshold area of said portal, transitions from said first region to said second region through said portal, said likelihood being based, at least in part, on said portal transition parameter.

37. The method as recited in claim 36, and further comprising with said mobile device:
estimating a current state of said mobile device including at least a location of the mobile device in said first region, said first region being identifiable by a first location context identifier (LCI) and said second region being identifiable by a second LCI which is different than the first LCI;
associating the current state with said portal; and
affecting operation of an application for selecting an LCI from among a plurality of LCIs responsive, at least in part, to said determined likelihood.

38. The method as recited in claim 37, wherein said application comprises an active scanning of wireless signals.

39. The method as recited in claim 36, and further comprising with said mobile device:
transmitting, to at least one other device, a request for said portal transition parameter.

40. The method as recited in claim 36, and further comprising with said mobile device:
selectively transmitting, to at least one other device, a request for positioning information corresponding to at least one location context identifier (LCI) based, at least in part, on said likelihood.

41. The method as recited in claim 36, and further comprising with said mobile device:
transmitting, to at least one other device, navigation information indicative of perceived movements of said mobile device within at least one of said first region or said second region.

42. An apparatus comprising
means for receiving a portal transition parameter corresponding to at least a portion of an electronic map of a specific environment, said portal transition parameter corresponding to a threshold area of a portal from a first region within said specific environment to a second region within said specific environment, and being based, at least in part, on a gathered history of mobile devices in said first region and within said threshold area of said portal; and
means for determining a likelihood that a mobile device, when located within said threshold area of said portal, transitions from said first region to said second region through said portal, said likelihood being based, at least in part, on said portal transition parameter.

43. The apparatus as recited in claim 42, and further comprising:
means for estimating a current state of said mobile device including at least a location of the mobile device in said first region, said first region being identifiable by a first location context identifier (LCI) and said second region being identifiable by a second LCI which is different than the first LCI;
means for associating the current state with said portal; and
means for affecting operation of an application for selecting an LCI from among a plurality of LCIs responsive, at least in part, to said determined likelihood.

44. The apparatus as recited in claim 43, wherein said application comprises means for performing an active scanning of wireless signals.

45. The apparatus as recited in claim 42, and further comprising:
means for transmitting, to at least one other device, a request for said portal transition parameter.

46. The apparatus as recited in claim 42, and further comprising:
means for selectively transmitting, to at least one other device, a request for positioning information corresponding to at least one location context identifier (LCI) based, at least in part, on said likelihood.

47. The apparatus as recited in claim 42, and further comprising:
means for transmitting, to at least one other device, navigation information indicative of perceived movements of said mobile device within at least one of said first region or said second region.

48. The apparatus as recited in claim 42, and further comprising:
means for receiving a request for navigation information from at least one other device.

49. A mobile device comprising:
memory; and
a processing unit in communication with the memory and configured to:
obtain, from said memory, a portal transition parameter corresponding to at least a portion of an electronic map of a specific environment, said portal transition parameter corresponding to a threshold area of a portal from a first region within said specific environment to a second region within said specific environment, and being based, at least in part, on a gathered history of mobile devices in said first region and within said threshold area of said portal; and
determine a likelihood that said mobile device, when located within said threshold area of said portal, transitions from said first region to said second region through said portal, said likelihood being based, at least in part, on said portal transition parameter.

50. The mobile device as recited in claim 49, said processing unit further configured to:
estimate a current state of said mobile device including at least a location of the mobile device in said first region, said first region being identifiable by a first location context identifier (LCI) and said second region being identifiable by second LCI which is different than the first LCI;
associate the current state with said portal; and
affect operation of an application for selecting an LCI from among a plurality of LCIs responsive, at least in part, to said determined likelihood.

51. The mobile device as recited in claim 50, wherein said application comprises an active scanning of wireless signals.

52. The mobile device as recited in claim 49, and further comprising:
a communication interface; and
said processing unit further configured to initiate transmission of a request for said portal transition parameter, via said communication interface to at least one other device.

53. The mobile device as recited in claim 49, and further comprising:
a communication interface; and
said processing unit further configured to initiate transmission, via said communication interface to at least one other device, of a request for positioning information corresponding to at least one location context identifier (LCI) based, at least in part, on said likelihood.

54. The mobile device as recited in claim 49, and further comprising:
a communication interface; and
said processing unit further configured to initiate transmission, via said communication interface to at least one other device, of navigation information indicative of perceived movements of said mobile device within at least one of said first region or said second region.

55. A non-transitory computer readable medium having computer implementable instructions stored therein which are executable by a processing unit of a mobile device to:
obtain a portal transition parameter corresponding to at least a portion of an electronic map of a specific environment, said portal transition parameter corresponding to a threshold area of a portal from a first region within said specific environment to a second region within said specific environment, and being based, at least in part, on a gathered history of mobile devices in said first region and within said threshold area of said portal; and
determine a likelihood that said mobile device, when located within said threshold area of said portal, transitions from said first region to said second region through said portal, said likelihood being based, at least in part, on said portal transition parameter.
